(19) United States
(12) Patent Application Publication
(10) Pub. No.: US 2024/0247212 A1
(43) Pub. Date: Jul. 25, 2024

(54) APPARATUS FOR MANUFACTURING FERMENTED BEVERAGES

(71) Applicant: INTHEKEG, INC., Seoul (KR)

(72) Inventors: Taeil KANG, Seoul (KR); Wonseok LEE, Gwangmyeong-si, Gyeonggi-do (KR); Changhun JEONG, Gunpo-si, Gyeonggi-do (KR); Byunggyu KANG, Seongnam-si, Gyeonggi-do (KR); Seungchul LEE, Seoul (KR); Yoonsang KIM, Seoul (KR)

(73) Assignee: INTHEKEG, INC., Seoul (KR)

(21) Appl. No.: 18/012,641

(22) PCT Filed: Nov. 10, 2020
(86) PCT No.: PCT/KR2020/015669

§ 371 Date: Jun. 29, 2023

(30) Foreign Application Priority Data
Jun. 24, 2020 (KR) 10-2020-0077455

(51) Int. Cl. C12C 11/00; B67D 1/00; B67D 1/04; B67D 1/07; B67D 1/08; C12C 13/10

(52) U.S. Cl. CPC C12C 11/006; B67D 1/0418; B67D 1/07; C12C 13/10; B67D 2001/0097; B67D 2001/0098; B67D 2001/0822; B67D 2210/00125

(57) ABSTRACT

The present invention relates to an apparatus and method for manufacturing fermented beverages and, more particularly, to an apparatus and method for manufacturing fermented beverages, by which handmade fermented beverages can be manufactured without professional knowledge or brewing equipment. According to an embodiment of the present invention, provided is an apparatus for manufacturing fermented beverages, the apparatus being characterized by comprising a flow path module connected to a keg in which an undiluted solution is stored. The flow path module includes: an undiluted solution flow path provided such that an undiluted solution moves therethrough; a gas flow path provided such that a gas moves therethrough; a coupler provided to independently connect the inside of the keg to the undiluted solution flow path and the gas flow path when coupled to a keg cap of the keg; an intermediate tank which is provided between the undiluted solution flow path and the gas flow path and communicates the undiluted solution flow path to the gas flow path; and a pump provided on the undiluted solution flow path.

### TECHNICAL FIELD

The present disclosure relates to a fermented beverage manufacturing apparatus and a manufacturing method thereof, and more specifically to a fermented beverage manufacturing apparatus for producing a handmade fermented beverage without professional knowledge or brewing equipment, and a manufacturing method thereof.

### BACKGROUND ART

Beer is an alcoholic drink made by making juice from malt made by sprouting barley, filtering the juice, adding hops, and fermenting the juice with hops with yeast.

This beer manufacturing method includes boiling malt to produce wort, supplying yeast to the work to ferment the wort, and aging the fermented beer, and beer sold in supermarkets and marts is manufactured by sterilizing the beer produced using the above method for distribution and storage and then being bottled or canned.

However, since yeast is killed when the aged beer is sterilized, currently distributed beers are beers in which the yeast is killed during the sterilization process.

On the other hand, craft beer is a beer in which yeast is alive, and refers to a unique beer produced directly to enhance the taste and aroma of beer. Such craft beer is only tasted in special places with brewing production facilities, and it is possible to make more than 100,000 different types of craft beer depending on which yeast and hops are added.

However, craft beer is only made through complex and diverse manufacturing processes. In particular, huge equipment investment, long manufacturing time, and a lot of labor are required in the fermentation and maturation process, which corresponds to an inefficient manufacturing system that requires professional personnel to directly manage the entire manufacturing process.

For fermentation after wort production, a process of transferring the wort contained in a wort container to a fermenter is required. In this case, since the quality of beer may be degraded because of contamination and oxygen contact due to external contact, all contact surfaces and flow paths need to be washed and sterilized such that there are no other germs, and accordingly, there is a problem in that a lot of time and labor are required.

That is, conventionally, enormous investment in facilities, equipment, and manpower are required to manufacture craft beer, and in this case, even when craft beer is manufactured with a small scale, hundreds of millions of investments in equipment and a large number of manpower need to be employed. In particular, there is a problem in that specialized knowledge or expertise in craft beer brewing are required.

In a conventional beer manufacturing apparatus, a large amount of beer is produced by fermenting a large amount of beer in one tank by making a large amount of wort at once. However, in this process, if even beer is slightly contaminated, the entire beer is contaminated and is not usable or when beer is not sold, beer needs to be stored for a long period of time and the quality of beer is degraded.

In order to resolve this problem, Korean Patent Application No. 10-2017-0119868 (hereinafter referred to as “Cited Reference”) discloses a beer manufacturing device for producing an appropriate amount of craft beer and various kinds of craft beer.

However, the above Cited Reference considers only a viewpoint of manufacturing craft beer and does not consider a viewpoint of a dispenser, such as how manufactured beer is dispensed. Therefore, the Cited Reference does not consider a viewpoint of a flow path through which the beer is dispensed and a viewpoint of cleaning or sterilizing the flow path.

The Cited Reference discloses a flow path through which gas and wort move in a beer manufacturing process. Here, the wort is moved by driving a pump. However, according to the Cited Reference, there is a problem in that the characteristics of the pump are not optimally considered. Therefore, there is a relatively high probability in that the durability of the pump is lowered or the pump malfunctions. In addition, a delay may occur during an operation of the pump, and thus it may not be easy to accurately control the flow.

The Cited Reference discloses a feature of branching and discharging gas generated during the beer manufacturing process from a gas line. In this case, residue or bubbles may be discharged with the gas, and thus there is a problem of contamination around a discharger.

The Cited Reference does not disclose details of the structure of a case of the beer manufacturing apparatus. In detail, it does not disclose a structural connection relationship of a plurality of chambers for defining a case.

Therefore, there is a need for a method for resolving the problems in a field of the conventional craft beer and the problems in the Cited Reference.

Beer is a fermented beverage, and alcohol such as wine or makgeolli is also a fermented beverage. That is, besides a difference that basic raw materials are barley, grapes, and rice, manufacturing methods of beer, wine, and makgeolli may be similar. In addition, the manufacturing method of fermented beverages such as kombucha, which is made by fermentation after adding symbiotic colony of bacteria & yeast (SCOBY) beneficial bacteria to an undiluted solution of green or black tea steeped in water and sugar, may be similar to the above manufacturing methods. Like beer, fermented beverages such as wine, makgeolli, and kombucha are not uniformly manufactured, but need to be manufactured in a variety of ways according to the tastes and preferences of consumers or manufacturers.

Therefore, it is necessary to provide an apparatus and control method for producing a fermented beverage through fermentation of an undiluted solution regardless of a type of fermented beverages further from beer.

### DISCLOSURE

### Technical Problem

The present disclosure is to resolve conventional problems.

An embodiment of the present disclosure provides a fermented beverage manufacturing apparatus and manufacturing method for independently manufacturing and independently cleaning a plurality of fermented beverages.

An embodiment of the present disclosure provides a fermented beverage manufacturing apparatus and manufacturing method for smoothly performing movement of an undiluted solution and gas in a manufacturing process of fermented beverage, improving the durability of a pump driven for movement of the undiluted solution and accurately controlling flow.

An embodiment of the present disclosure provides a fermented beverage manufacturing apparatus and manufacturing method for effectively cleaning a flow module in which an undiluted solution and gas are moved during a manufacturing process of fermented beverage.

An embodiment of the present disclosure provides a fermented beverage manufacturing apparatus and manufacturing method for relatively increasing the manufacturing capacity of fermented beverages by dispensing a plurality of fermented beverages through a single cock to ensure the convenience of dispensing and simplifying a dispensing structure.

An embodiment of the present disclosure provides a fermented beverage manufacturing apparatus and manufacturing method for effectively excluding mixing and dispensing of different types of fermented beverages even when a plurality of fermented beverages are dispensed with a single cock.

An embodiment of the present disclosure provides a fermented beverage manufacturing apparatus and manufacturing method for effectively and easily cleaning not only the flow module but also the entire path until fermented beverage is moved and dispensed.

An embodiment of the present disclosure provides a fermented beverage manufacturing apparatus and manufacturing method for flexibly coping with various usage scenarios by vertically forming chambers in a circumferential direction of a rotatable case, dispensing fermented beverage through a specific upper chamber (dispensing chamber), and arranging common components of a lower chamber (common chamber) of the dispensing chamber.

An embodiment of the present disclosure provides a fermented beverage manufacturing apparatus that is to be purchased and used easily like home appliances at home or in a business, and a manufacturing method of the apparatus. In particular, the embodiment of the present disclosure provides a fermented beverage manufacturing apparatus and manufacturing method for producing different fermented beverages at the same time and dispensing each of the manufactured fermented beverages.

An embodiment of the present disclosure provides a fermented beverage manufacturing apparatus for minimizing an installation space and improving manufacturing and durability.

An embodiment of the present disclosure provides a fermented beverage manufacturing apparatus for simplifying a cold air supply structure by applying a cell structure such that a plurality of chambers are implemented through each cell structure and cold air is supplied through a space surrounded by cell structures.

### Technical Solution

To achieve the aforementioned objectives, according to an embodiment of the present disclosure, a fermented beverage manufacturing apparatus including a flow module connected to a keg with an undiluted solution stored therein is provided, the flow module includes an undiluted solution flow path configured to move an undiluted solution therethrough, a gas flow path configured to move gas therethrough, a coupler configured to independently connect an inside of the keg to the undiluted solution flow path and the gas flow path while being coupled to a keg cap of the keg, a medium tank provided between the undiluted solution flow path and the gas flow path and configured to communicate the undiluted solution flow path with the gas flow path, and a pump provided on the undiluted solution flow path.

The fermented beverage manufacturing apparatus may further include a tank coupler coupled to a cap of the medium tank and configured to independently connect an inside of the medium tank to the undiluted solution flow path and the gas flow path.

When the coupler is combined with the cap of the keg, the flow module may define a closed flow path, through driving of the pump, an undiluted solution may be moved from the keg to the medium tank or from the medium tank to the keg via the pump, and gas may be moved from the medium tank to the keg or from the keg to the medium tank through the gas flow path.

The undiluted solution flow path may include a first undiluted solution flow path provided between the coupler and the pump, and a second undiluted solution flow path provided between the pump and the medium tank.

The manufacturing apparatus or the flow module may further include a fermented beverage flow path branched from the first undiluted solution flow path and configured to dispense an undiluted solution inside the keg to an outside.

The first undiluted solution flow path may include a pump valve and a flow meter configured to selectively open and close the first undiluted solution flow path.

The pump valve may be provided between the pump and a branch point at which the fermented beverage flow path is branched from the first undiluted solution flow path, and the flow meter may be provided between the branch point and the coupler.

The fermented beverage manufacturing apparatus may further include a dispensing valve configured to selectively open and close the fermented beverage flow path on a downstream side of the branch point.

The manufacturing apparatus or the flow module may further include a carbon dioxide flow path branched on the gas flow path and configured to supply carbon dioxide from a carbon dioxide tank to an inside of the gas flow path.

A carbon dioxide valve, a check valve, and a carbon dioxide pressure gauge that are configured to selectively open and close the carbon dioxide flow path, and a pressure regulator configured to control a supply pressure of carbon dioxide supplied to the carbon dioxide flow path may be provided on an upstream side of the branch point at which the carbon dioxide flow path is branched from the gas flow path.

The carbon dioxide may be supplied to the gas flow path through the pressure regulator, the pressure gauge, the check valve, and the carbon dioxide valve in sequence.

The manufacturing apparatus or the flow module may further include a gas valve configured to selectively open and close the gas flow path, and the gas valve may be provided between the medium tank and a branch point at which the carbon dioxide flow path is branched from the gas flow path.

The fermented beverage manufacturing apparatus may further include a gas pressure gauge configured to detect a pressure inside the gas flow path between the gas valve and the branch point at which the carbon dioxide flow path is branched from the gas flow path.

A branch point at which a flow path is branched may be excluded on the gas flow path between the gas valve and the medium tank.

When the coupler is directly coupled to a coupler holder, the coupler may directly connect the undiluted solution flow path and the gas flow path through the coupler holder.

When the coupler is combined with the cap of the keg, the flow module may define a closed flow path, and through driving of the pump, a cleaning solution accommodated in the medium tank may be returned to an inside of the medium tank after flowing through an entire flow module.

A flow path of the undiluted solution or gas may be defined by the flow module in at least one of a process of supplying yeast to the undiluted solution, a fermentation process of the undiluted solution, and an infusing process.

To achieve the aforementioned objectives, according to an embodiment of the present disclosure, a fermented beverage manufacturing apparatus including a flow module connected to a keg with an undiluted solution stored therein is provided, the flow module including a coupler holder, an undiluted solution flow path configured to move an undiluted solution therethrough, a gas flow path configured to move gas therethrough, a coupler configured to directly connect the undiluted solution flow path and the gas flow path through the coupler holder when being coupled to the coupler holder, a medium tank provided between the undiluted solution flow path and the gas flow path and configured to communicate the undiluted solution flow path with the gas flow path, and a pump provided on the undiluted solution flow path.

The coupler may be coupled to the coupler holder during cleaning of the flow module, and coupled to a keg cap of the keg when a fermented beverage is manufactured through the flow module.

When the coupler is combined with the coupler holder, the flow module may define a closed flow path, and through driving of the pump, the cleaning solution accommodated in the medium tank may be recovered into the medium tank after flowing through the entire flow module to clean an inside of the flow module.

The undiluted solution flow path may include a first undiluted solution flow path provided between the coupler and the pump, and a second undiluted solution flow path provided between the pump and the medium tank.

The manufacturing apparatus or the flow module may further include a fermented beverage flow path branched from the first undiluted solution flow path and configured to dispense an undiluted solution inside the keg to an outside.

The fermented beverage manufacturing apparatus may further include a dispensing valve configured to selectively open and close the fermented beverage flow path on a downstream side of the branch point.

The dispensing valve may be closed during cleaning of the flow module, and opened when the cleaning solution in the flow module is discharged to the fermented beverage flow path after the flow module is cleaned.

The first undiluted solution flow path may include a pump valve and a flow meter configured to selectively open and close the first undiluted solution flow path.

The pump valve may be provided between the pump and a branch point at which the fermented beverage flow path is branched from the first undiluted solution flow path.

The manufacturing apparatus or the flow module may further include a carbon dioxide flow path branched on the gas flow path and configured to supply carbon dioxide from a carbon dioxide tank to an inside of the gas flow path.

The manufacturing apparatus or the flow module may further include a gas valve configured to selectively open and close the gas flow path and a carbon dioxide valve configured to selectively open and close the carbon dioxide flow path, and the gas valve may be provided between the medium tank and a branch point at which the carbon dioxide flow path is branched from the gas flow path.

After the cleaning solution in the flow module is discharged to the fermented beverage flow path, the carbon dioxide valve may be open to pressurize an inside of the flow module.

When the carbon dioxide valve is open, the gas valve and the pump valve may be open, and the dispensing valve may be closed.

After an inside of the flow module is pressurized, the dispensing valve may be open such that the cleaning solution remaining inside the flow module is discharged through the fermented beverage flow path.

A flow path of the undiluted solution or gas may be defined by the flow module in at least one of a process of supplying yeast to the undiluted solution, a fermentation process of the undiluted solution, and an infusing process.

To achieve the aforementioned objectives, a fermented beverage manufacturing apparatus including a flow module through which an undiluted solution and gas are moved to manufacture an undiluted solution stored in a keg as a fermented beverage is provided, the flow module including an undiluted solution flow path configured to move an undiluted solution therethrough in a process of manufacturing the fermented beverage, a gas flow path configured to move gas therethrough in the process of manufacturing a fermented beverage, a middle holder provided between the undiluted solution flow path and the gas flow path and configured to communicate the undiluted solution flow path with the gas flow path, a pump provided on the undiluted solution flow path, and a coupler connected to a cleaning tank accommodating a cleaning solution instead of the keg and configured to independently connect an inside of the cleaning tank to the undiluted solution flow path and the gas flow path when an inside of the flow module is cleaned.

Features in the above-described embodiments may be applied in combination in other embodiments as long as they are not contradictory or exclusive.

### Advantageous Effects

An embodiment of the present disclosure provides a fermented beverage manufacturing apparatus and manufacturing method for independently manufacturing and independently cleaning a plurality of fermented beverages.

An embodiment of the present disclosure provides a fermented beverage manufacturing apparatus and manufacturing method for smoothly performing movement of an undiluted solution and gas in a manufacturing process of fermented beverage, improving the durability of a pump driven for movement of the undiluted solution and accurately controlling flow.

An embodiment of the present disclosure provides a fermented beverage manufacturing apparatus and manufacturing method for effectively cleaning a flow module in which an undiluted solution and gas are moved during a manufacturing process of fermented beverage.

An embodiment of the present disclosure provides a fermented beverage manufacturing apparatus and manufacturing method for relatively increasing the manufacturing capacity of fermented beverages by dispensing a plurality of fermented beverages through a single cock to ensure the convenience of dispensing and simplifying a dispensing structure.

An embodiment of the present disclosure provides a fermented beverage manufacturing apparatus and manufacturing method for effectively excluding mixing and dispensing of different types of fermented beverages even when a plurality of fermented beverages are dispensed with a single cock.

An embodiment of the present disclosure provides a fermented beverage manufacturing apparatus and manufacturing method for effectively and easily cleaning not only the flow module but also the entire path until fermented beverage is moved and dispensed.

An embodiment of the present disclosure provides a fermented beverage manufacturing apparatus and manufacturing method for flexibly coping with various usage scenarios by vertically forming chambers in a circumferential direction of a rotatable case, dispensing fermented beverage through a specific upper chamber (dispensing chamber), and arranging common components of a lower chamber (common chamber) of the dispensing chamber.

An embodiment of the present disclosure provides a fermented beverage manufacturing apparatus that is to be purchased and used easily like home appliances at home or in a business, and a manufacturing method of the apparatus. In particular, the embodiment of the present disclosure provides a fermented beverage manufacturing apparatus and manufacturing method for producing different fermented beverages at the same time and dispensing each of the manufactured fermented beverages.

An embodiment of the present disclosure provides a fermented beverage manufacturing apparatus for minimizing an installation space and improving manufacturing and durability.

An embodiment of the present disclosure provides a fermented beverage manufacturing apparatus for simplifying a cold air supply structure by applying a cell structure such that a plurality of chambers are implemented through each cell structure and cold air is supplied through a space surrounded by cell structures.

### DESCRIPTION OF DRAWINGS

FIG. 1 shows a fermented beverage manufacturing apparatus according to an embodiment of the present disclosure.

FIG. 2 shows an assembly process of the fermented beverage manufacturing apparatus of FIG. 1 and shows a fermented beverage manufacturing apparatus before some cell cases overlap each other.

FIG. 3 shows a state in which a cell defining a keg, and a flow module and a keg that are provided inside the cell case are dissembled.

FIG. 4 is an enlarged view showing a state in which a lower cell frame, a hinge, a cell case, a door, a decoration panel, and a duct are combined.

FIG. 5 is an enlarged view showing a state in which a decoration panel, a cell ca se, and a lower cell frame are combined through a hinge.

FIG. 6 schematically shows a horizontal cross section of a fermented beverage manufacturing apparatus based on an inner cell case and an evaporator assembly.

FIG. 7 shows an appearance of an inner cell case.

FIG. 8 shows a state in which a back cover and a flow module are mounted on an inner cell case.

FIG. 9 shows a back cover.

FIG. 10 shows a detailed configuration of a flow module.

FIG. 11 shows a configuration of a flow path for dispensing a plurality of fermented beverages through a single dispenser assembly.

FIG. 12 shows a configuration of a dispenser assembly, especially an internal configuration.

FIG. 13 schematically shows a first cleaning process for cleaning flow paths including flow modules.

FIG. 14 schematically shows a second cleaning process for cleaning flow paths including flow modules.

FIG. 15 schematically shows a third cleaning process for cleaning flow paths including flow modules.

FIG. 16 shows control of a flow module in a yeast injecting process.

FIG. 17 shows control of a flow module in a primary fermentation process.

FIG. 18 shows control of a flow module for relieving excessive pressure in the primary fermentation process.

FIG. 19 shows control of a flow module in an infusing process.

FIG. 20 shows control of a flow module in a secondary fermentation process.

FIG. 21 shows control of a flow module in an aging process.

FIG. 22 shows control of an entire flow path controlled in a dispensing process.

### BEST MODE

Hereinafter, a fermented beverage manufacturing apparatus according to an embodiment of the present disclosure will be described with reference to the accompanying drawings.

The fermented beverage described herein is prepared by fermenting an undiluted solution such as wort, such as beer or makgeolli. In this specification, for convenience, beer is assumed as an example of the fermented beverage. Terms based on beer are explained, but the present embodiment is not limited to beer, which is an example of the fermented beverage.

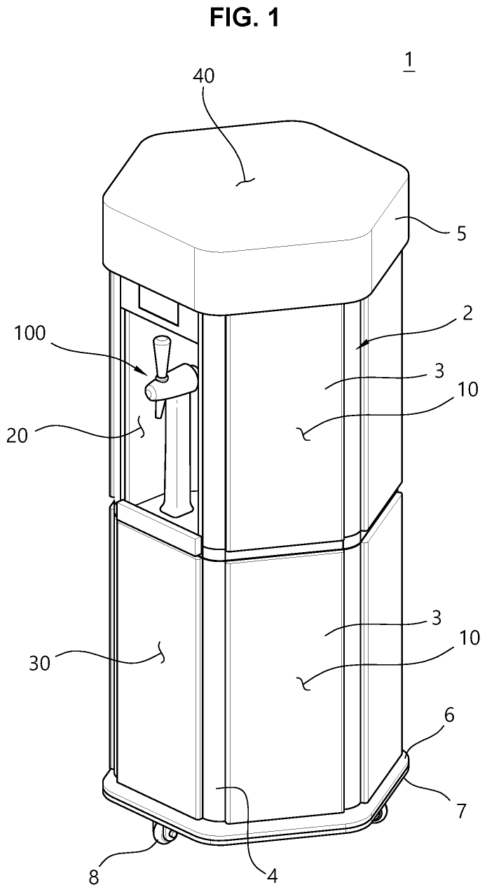

FIG. 1 illustrates a fermented beverage manufacturing apparatus according to the present embodiment.

As shown in the drawing, a fermented beverage manufacturing apparatus 1 may include a case 2 and a plurality of doors 10 defining an external shape.

The case 2 may include a machine room housing 5. The machine room housing 5 may be located above the fermented beverage manufacturing apparatus 1. That is, the machine room housing 5 may be provided to define a machine room and protect components inside the machine room from the outside.

The fermented beverage manufacturing apparatus 1 may include a plurality of cells. The cells may each include a chamber, and may be distinguished from each other according to a function of the chamber, and may be classified into a keg cell, a dispensing cell, and a common cell. Each cell may constitute a part of the case 2. That is, a plurality of cells may be connected to form a support structure of a fermented beverage manufacturing apparatus. A cell is formed through a cell case. Details on this will be described later.

A container that accommodates the undiluted solution of a fermented beverage may be called a keg. The undiluted solution of a fermented beverage becomes a fermented beverage through the manufacturing process, and the fermented beverage may also be accommodated in the same keg. A chamber including the keg may be referred to as a keg chamber 10. A fermented beverage may be prepared and stored from an undiluted solution through a keg provided inside the keg chamber 10. The keg chamber 10 may be provided in plurality. Each keg chamber may include a keg, and thus different types of fermented beverages may be produced. Production of fermented beverages through the keg chamber 10 may be performed independently of each other. Thus, different fermented beverages may be produced at the same time. To this end, each keg chamber includes a flow module.

A chamber for dispensing the manufactured fermented beverage to the outside may be referred to as a dispensing chamber 20 or a dispenser chamber. A dispenser assembly 100 for dispensing the fermented beverage is provided inside the dispensing chamber 20.

According to the present embodiment, fermented beverages manufactured in the plurality of keg chambers 10 may be dispensed through a single dispenser assembly 100. That is, a single dispensing chamber 20 may be provided. Also, the single dispenser assembly 100 may be provided in the single dispensing chamber 20, and a single cock may be provided in the single dispenser assembly 100. A selected fermented beverage among a plurality of fermented beverages may be dispensed through the single cock.

The plurality of chambers may include the keg chamber 10 and the dispensing chamber 20 as well as a common chamber 30. The common chamber 30 may be a chamber for accommodating a component for cleaning a dispenser assembly or components such as a carbon dioxide tank necessary for dispensing fermented beverages after manufacturing the fermented beverages. That is, the common chamber 30 may be a chamber that accommodates components connected to a plurality of independently provided keg chambers 10 or dispensing chambers 20.

A detailed description of components such as a flow module or a carbon dioxide tank will be described later.

Components for executing a cooling cycle may be provided in the above-described machine room 40. The durability of these cooling cycle configurations is sufficiently ensured. In addition, the components do not require frequent user access. Accordingly, the machine room 40 may be positioned above the fermented beverage manufacturing apparatus 1.

As shown in FIG. 1, the fermented beverage manufacturing apparatus 1 according to the present embodiment may have a hexagonal cross section. Chambers may be formed on the top and bottom of one surface, respectively. Since the fermented beverage manufacturing apparatus 1 has a total of 6 surfaces, a total of 12 chambers may be provided along a circumference of the fermented beverage manufacturing apparatus. That is, a total of 6 chambers are formed in a circumferential direction on a first floor, and a total of 6 chambers are formed in the circumferential direction on a second floor. The size and position of the cell case in which the chamber is formed may be symmetrical to each other. Therefore, the hexagon may be a regular hexagon.

Here, the 10 chambers may be the keg chamber 10, one chamber may be the dispensing chamber 20, and the remaining one may be the common chamber 30. In order to manufacture a fermented beverage with a largest capacity in a limited size of the fermented beverage manufacturing apparatus 1, a single dispensing chamber and a single common chamber may be formed, and the remaining chambers may be formed as keg chambers. This is because when a plurality of dispensing chambers or common chambers are provided, the number of keg chambers is reduced, resulting in a decrease in fermented beverage manufacturing capacity.

Since the keg chamber 10 is a space for manufacturing a fermented beverage, the keg chamber 10 may be a space that requires heating or cooling. Therefore, the keg chamber 10 needs to be insulated from the outside, and a door 3 is provided for this purpose. That is, a door for opening and closing the chamber may be provided. The door 3 may be formed as an insulated door, and the door 3 may be provided for each of the keg chambers 10. Through this, independent cooling and independent heating may be performed.

The common chamber 30 may be a space accommodating a carbon dioxide tank or a drain tank. These components may not be exposed to the outside. Accordingly, the door 3 for opening and closing the common chamber 30 may also be provided. The door of the common chamber may also be an insulated door, but may not be an insulated door since temperature control inside the chamber may be unnecessary.

The dispensing chamber 20 is a chamber for dispensing manufactured fermented beverage. Therefore, the dispensing chamber 20 is a chamber most frequently accessed by a user. In order to dispense the fermented beverage, the user needs to hold a container such as a drinking cup and insert the container into the chamber. Therefore, for ease of use, the dispensing chamber 20 may not be provided with a door.

A frequency of user access to the keg chamber 10 is relatively very low. That is, when replacing a keg, a user may generally access the keg chamber, and it takes a relatively long time to manufacture and consume a fermented beverage in the installed keg.

On the other hand, the frequency of user access to the common chamber 30 may be greater than that of the keg chamber 10 and less than that of the dispensing chamber 20. This is because a frequency of management of common components, such as replacement of a carbon dioxide tank or cleaning of a drain tank, may be relatively high. Therefore, it may be possible to implement an optimized chamber arrangement according to a frequency of use of the user by forming the common chamber 30 under the dispensing chamber 20. This is because the dispensing chamber 20 and the common chamber 30 may be exposed in front of a path of the user.

In consideration of a frequency of access to the chambers and an approach posture of the user, the dispensing chamber 20 may be positioned above the common chamber 30. That is, it may be very easy to dispense the fermented beverage by positioning the dispenser assembly 100 according to an average height of the user.

Unlike the above description, the machine room may be positioned below the chambers. However, in this case, since the height of the dispenser assembly 100 is inevitably increased, it may not be easy to dispense the fermented beverage. In addition, the inside of the machine room is formed as an empty space, and cooling cycle components are provided therein. Therefore, it is not desirable to allow the machine room itself to support vertical load.

Needless to say, a machine room chamber may be formed similarly to the common chamber. However, in this case, there is a problem in that the capacity for producing fermented beverages is reduced because the number of keg chambers is inevitably reduced. In addition, it is not easy to configure a cooling cycle by accommodating components such as a compressor, a condenser, and a condenser fan in a small space. Therefore, the machine room may be located above the chambers, that is, on top of the fermented beverage manufacturing apparatus.

When the positions of the dispensing chamber 20 and the common chamber 30 are fixed, access to the keg chamber 10 may not be easy. For example, in order to access the keg chamber 10 located behind the dispensing chamber 20, a user needs to move to a rear surface of the fermented beverage manufacturing apparatus 1. In this case, a space accessible to the user through an entire circumference of the fermented beverage manufacturing apparatus 1 is required. That is, an excessively large installation space is required.

In order to resolve this problem, in the present embodiment, the fermented beverage manufacturing apparatus 1 may be provided to be rotatable with respect to the ground. That is, even if an access space of the user is ensured only in front of the fermented beverage manufacturing apparatus 1, it may be sufficient. This is because when a user approaches a specific keg chamber, the fermented beverage manufacturing apparatus 1 may be rotated to position a specific keg chamber in front of the user. Therefore, a relatively small installation space is required. In other words, only a space accessible to the user from a front side like in a refrigerator may be required.

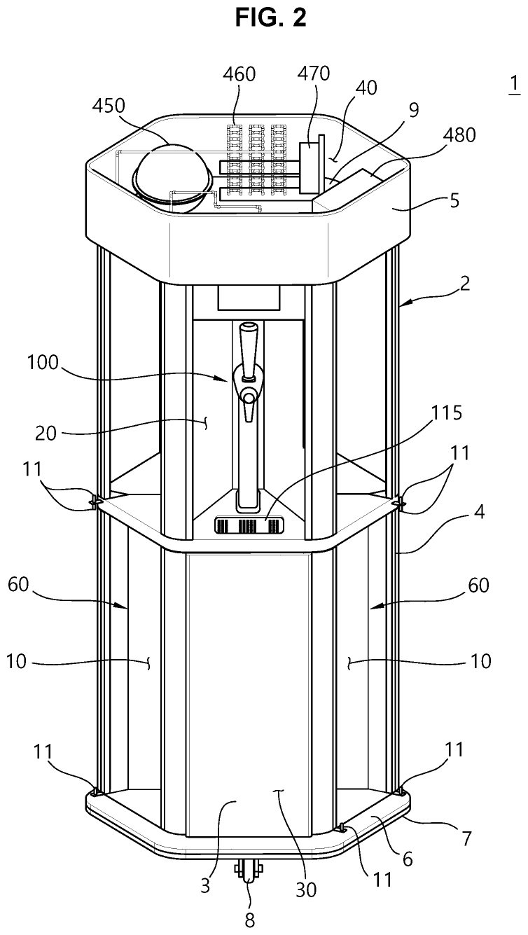

As shown in FIG. 2, the fermented beverage manufacturing apparatus 1 may be relatively heavy and may include a caster 8 to facilitate horizontal movement. The caster 8 may be combined with a bottom frame 7.

A lower cell frame 6 may be provided above the bottom frame 7. The lower cell frame 6 may be formed to face the bottom frame 7. A circular thrust bearing may be provided between the bottom frame 7 and the lower cell frame 6. That is, vertical load transmitted through the lower cell frame 6 is rotatably supported by the thrust bearing. The lower cell frame 6 and the bottom frame 7 are spaced apart from each other in upward and downward directions by bearings.

Accordingly, the lower cell frame 6 may rotate while the bottom frame 7 is fixed. This rotation means that the fermented beverage manufacturing apparatus 1 excluding the bottom frame 7 and the caster is capable of rotating horizontally. Therefore, it is not necessary to ensure an extra installation space, and thus usability may be increased. This is because the user is capable of accessing all chambers in one direction by rotating the fermented beverage manufacturing apparatus.

Since the entire machine room as well as the plurality of chambers rotates together, additional components for rotation between the machine room and the chambers are not required. Specifically, there is no need for configurations to allow relative rotation between the machine room and chambers while supporting vertical load. This is because the fermented beverage manufacturing apparatus 1 excluding the bottom frame 7 may be rotated as a whole and integrally.

Therefore, as described later, a very effective and compact cooling air supply structure may be provided. In addition, the detailed configuration of the case 2 constituting the structure of the fermented beverage manufacturing apparatus 1 may be manufactured very simply.

The case 2 may include decoration panels 4 provided at a corner portion. Chambers may be provided vertically with both the decoration panels 4 therebetween. The decoration panels 4 may be provided to support vertical load and lateral external force. In addition, the decoration panels 4 may provide a beautiful design by forming a portion exposed to the outside at a corner portion of the fermented beverage manufacturing apparatus 1.

However, the fermented beverage manufacturing apparatus 1 according to the present embodiment may apply the independent cell structures as described above and may support vertical load and lateral external force by itself due to engagement between cells. That is, vertical engagement may be formed between a first-layer cell case and a second-layer cell case, and circumferential engagement may be performed between the cell cases of the respective layers, and thus structurally very stable manufacturing may be achieved. Engagement may be performed between the cell cases of the respective layers in a radial direction through an evaporator assembly.

In other words, the decoration panels 4 supporting the vertical load and lateral external force are unnecessary, and the decoration panel in terms of design may be provided.

When the decoration panels 4 perform a function of a pillar supporting vertical load, the decoration panels 4 may be made of a metal material. Needless to say, the decoration panels 4 may also be thick enough to support vertical load.

On the other hand, when the decoration panels 4 perform a decorative function provided at corners, the decoration panels 4 may be made thin enough and made of synthetic resin or wood instead of metal. Therefore, effects such as reduction in manufacturing cost, ease of manufacture, and weight reduction may be obtained.

Hereinafter, with reference to FIGS. 2 to 6, the case 2 and cooling cycle configuration of the fermented beverage manufacturing apparatus 1 will be described in more detail.

As shown in FIG. 2, the case 2 may include the lower cell frame 6 and an upper cell frame 9. Since the fermented beverage manufacturing apparatus has a hexagonal cross section, the lower cell frame 6 and the upper cell frame 9 may also have hexagonal shapes corresponding thereto.

The decoration panel 4 may be provided at each corner of the hexagon. The corner may be a space in which front openings of neighboring chambers are spaced apart from each other. Therefore, the decoration panels 4 may be a component for shielding this empty space.

The decoration panel 4 may be divided into upper and lower parts and connected to each other. That is, an upper end of the upper decoration panel 4 may be combined with the upper cell frame 9, and a lower end of the lower decoration panels 4 may be combined with the lower cell frame 6. The upper end of the upper decoration panel 4 and the upper end of the lower decoration panel 4 may be combined together.

Here, the decoration panels 4 may be provided for mounting a door hinge 11. That is, the hinge 11 may be interposed between the upper end of the decoration panel 4 and the upper cell frame 9 to perform coupling therebetween, and the hinge 11 may be interposed between the lower end of the decoration panel 4 and the lower cell frame 6 to perform coupling therebetween. In addition, the upper and lower two hinges 11 may be interposed between the lower end of the upper decoration panel 4 and the upper end of the lower decoration panel 4 to perform coupling therebetween. At this time, the two hinges 11 may also be combined with the upper cell frame and the lower cell frame, respectively. Thus, the hinge may be firmly coupled and fixed.

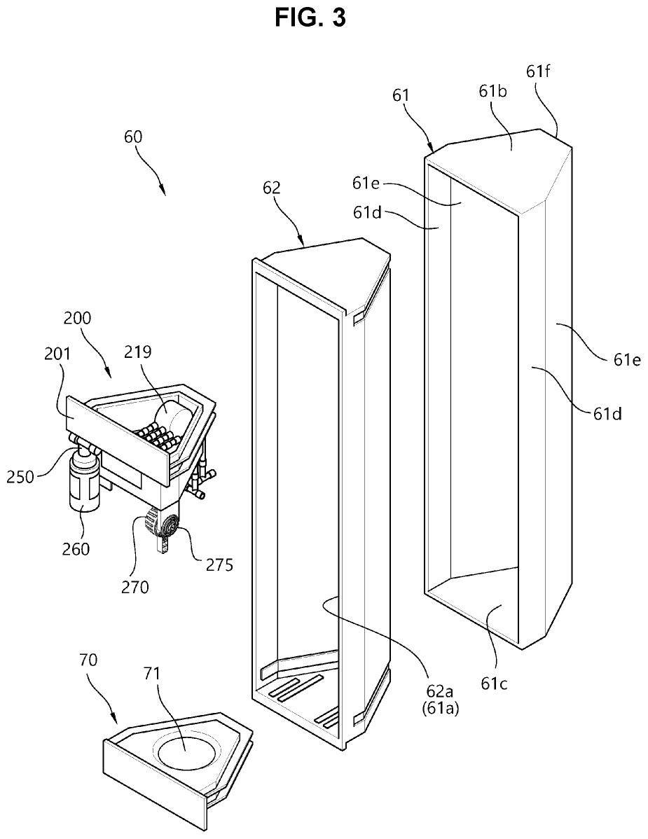

FIG. 3 shows a cell case 60, and in particular, a cell case defining a keg chamber. A cell case defining a dispenser chamber or a common chamber may be the same or similar to the cell case shown in the drawing.

The cell case 60 may be defined by including an outer cell case 61 and an inner cell case 62. Both the outer cell case 61 and the inner cell case 62 have an open front shape. The inner cell case 62 may be inserted into the front opening of the outer cell case 61 to integrally form the cell case 60.

The inner cell case 62 may be formed through injection or vacuum molding. That is, the inner cell case 62 may be formed of a synthetic resin material. Since the inner cell case 62 forms a chamber, the inner cell case 62 may be formed of a synthetic resin material to improve texture and ease of cleaning.

The outer cell case 61 may be manufactured using a steel plate. The outer cell case 61 forms a structure in which a top surface, a bottom surface, and side surfaces are all connected except for the front opening. That is, the outer cell case 61 itself may support vertical and horizontal loads as a single block. Of course, the inner cell case 62 may have the same shape as the outer cell case 61, but the size of the inner cell case 62 may be small such that the inner cell case 2 may be inserted into and accommodated in the outer cell case.

The inner cell case 62 may be inserted into the outer cell case 61 and integrally formed through a foaming process. That is, the cell case 60 forms a single configuration. The foam between the inner cell case 62 and the outer cell case 61 serves to improve insulation performance. Needless to say, an insulating material other than foam may be interposed between the inner cell case and the outer cell case. Therefore, the cell case 60 may be combined with the above-described insulated door 3 to form a chamber, which is an internal space, as an insulation space.

When the cell case 60 forms the keg chamber 10, a keg supporter 70 and a flow module 200 may be provided inside the inner cell case 62. The flow module 200 may include a tank coupler 250, a medium tank 260, a coupler 270, and a pump 219. In addition, the flow module 200 may include a module case 201 for accommodating and shielding some components. Details of the keg supporter 70 and the flow module 200 will be described later.

The case 2 of the fermented beverage manufacturing apparatus 1 according to the present embodiment may include the plurality of cell cases 60. That is, the plurality of cell cases may support vertical load and horizontal load while stacking up and down and engaging in a circumferential direction. Accordingly, a component such as a cabinet for accommodating a plurality of cell cases is not required.

FIG. 2 shows an example in which a total of six cell cases 60 are mounted on a lower part (first layer) of the fermented beverage manufacturing apparatus 1, and shows an example in which a cell case constituting a dispensing chamber is mounted on an upper part (second layer).

Five empty spaces may be formed in a circumferential direction in the dispensing chamber, and a total of five cell cases 60 may be inserted and mounted in these spaces.

With regard to an assembly sequence, six cell cases 60 may be mounted on the lower cell frame 6, the six cell cases may be mounted thereon again, and then an upper cell case positioned at an upper part may be combined with the lower cell frame 6. Thereafter, the machine room 40 may be formed. By combining the machine room housing to surround the upper cell frame, a machine room may be formed inside the upper part of the fermented beverage manufacturing apparatus 1.

At this time, the decoration panels 4 may be first coupled between the lower cell frame 6 and the upper cell frame 9, and the decoration panels 4 may be coupled after mounting the cell cases 60.

Therefore, in the fermented beverage manufacturing apparatus 1 according to the present embodiment, the case 2 defining basic appearance of the fermented beverage manufacturing apparatus 1 may be formed through the lower cell frame 6, the plurality of cell cases 60 engaged with each other, and the upper cell frame 9. Therefore, the fermented beverage manufacturing apparatus 1, which is very simple and is easily manufactured, may be manufactured. In particular, since chambers that need to have an insulating space may be implemented through the cell case 60 each independently having an insulating wall, it may be very easy and simple to ensure the insulating performance and form the insulating wall.

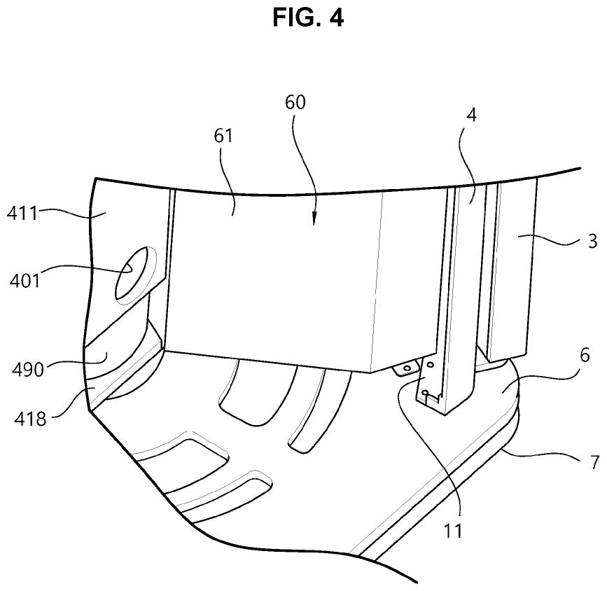

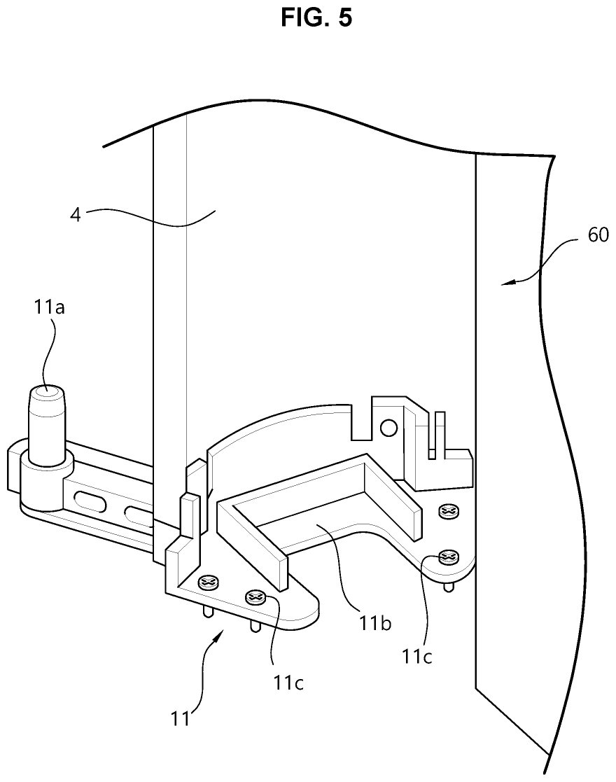

As shown in FIGS. 4 and 5, a hinge axis 11a of the door hinge 11 pivotably supporting a door 30 needs to be located radially outside the decoration panels 4 in consideration of a rotation radius of the door 30.

To this end, the door hinge 11 may include a hinge bracket 11b and may include the hinge axis 11a extending outward from the hinge bracket 11b. The hinge bracket 11b and the hinge axis 11a may be integrally formed, or the hinge axis 11a may be coupled to the hinge bracket 11b to form one hinge assembly.

The hinge bracket 11b may be fixedly coupled to the lower cell frame 6 or the upper cell frame 9 through a screw coupler 11c. At this time, the hinge bracket 11b may be shape-coupled to the decoration panels 4. That is, the decoration panels 4 may be coupled to the lower cell frame 6 or the upper cell frame 9 through the hinge bracket 11b.

In addition, the hinge bracket 11b may be combined with a cell case 50. The cell case 50 may be fixedly coupled to the lower cell frame 6 or the upper cell frame 9 by combining the hinge bracket 11b with the lower cell frame 6.

The cell case 50 is a component for forming a chamber therein. The case 2 includes a plurality of cell cases 50 engaged with each other in a circumferential direction. The plurality of cell cases 50 may be stacked in two layers.

Here, it may be considered that the cell case is fixedly coupled to the lower cell frame 6 or the upper cell frame 9 through lower and upper surfaces of the cell case 50. This fixed coupling may be performed through screws.

However, when the cell cases 50 constitutes an insulating wall, there is a concern that insulation performance is degraded when the cell cases 50 are coupled through bottom and top surfaces of the cell case. Therefore, the cell case 60 may be combined with the lower cell frame 6 or the upper cell frame 9 while minimizing a coupling portion through a side surface of the cell case.

In particular, the cell case 60 and the decoration panels 4 may be fixedly coupled to the cell frames 6 and 9 using the hinge 11. This is because, since the hinge 11 is coupled to the cell frames 6 and 9 outside the cell case 60, the insulating wall may be prevented from being damaged even if screw coupling is performed. In this case, the hinge 11 may be shape-coupled to the cell case 60 and the decoration panels 4 and the hinge 11 may be fixed to the cell frames 6 and 9, and thus the cell case 60 and the decoration panels 4 may be fixed to cell frames 6 and 9.

A total of two hinges 11 are required for the two upper and lower doors 30. Therefore, the two middle hinges may not be fixed or coupled to the cell frames 6 and 9.

As shown in FIG. 2, when the cell case 60 and the cell case 60 are in close contact, a space is formed at a corner of the fermented beverage manufacturing apparatus 1. The decoration panels 4 are formed separately from the top and bottom. Accordingly, it may be possible to fixedly couple two middle hinges using a space of the corner and upper and lower connection parts of the decoration panels 4.

Most components of the cooling cycle are accommodated in the machine room 40. A side surface of the machine room is shielded through the machine room housing 5, and the machine room housing 5 may be provided to shield a top surface of the machine room. However, the top surface of the machine room may be open to enable smooth heat exchange through the condenser.

The machine room 40 may include a compressor 450, a condenser 460, and a condenser fan 470. In addition, a relatively large power supply unit (SMPS) 480 may also be accommodated in the machine room. The evaporator for supplying cold air to the keg chamber may not be located in the machine room. This is because a separation distance between the machine room and each chamber is relatively large, and thus there is a risk of cold air loss. Accordingly, components related to the evaporator may be located in an empty space 50 substantially in the center of the fermented beverage manufacturing apparatus 1. Needless to say, a refrigerant pipe may also be provided in the machine room and outside the machine room.

As seen from FIG. 4, a duct 411 may be in close contact with a rear wall of the cell case 60. A defrost water tank 490 may be provided below the duct 411. It may be seen that an inlet 401 for supplying cold air to the inside of the cell case is formed in the duct 411.

The duct 411, an evaporator 410, and the defrost water tank 490 may constitute one evaporator assembly 400. To this end, plates 418 may be provided on the top and bottom of the evaporator assembly, respectively. The cross section of the plate may be formed to be shaped in the empty space 50 in a hexagonal shape.

An opening may be formed in the center of the upper cell frame 9, that is, in an upper part of the empty space, and the evaporator assembly 400 may be inserted through the opening. An upper plate of the evaporator assembly closes the opening. Needless to say, the evaporator assembly 400 may be mounted on the lower cell frame 6 and then the lower cell frame may be mounted above the evaporator assembly 400.

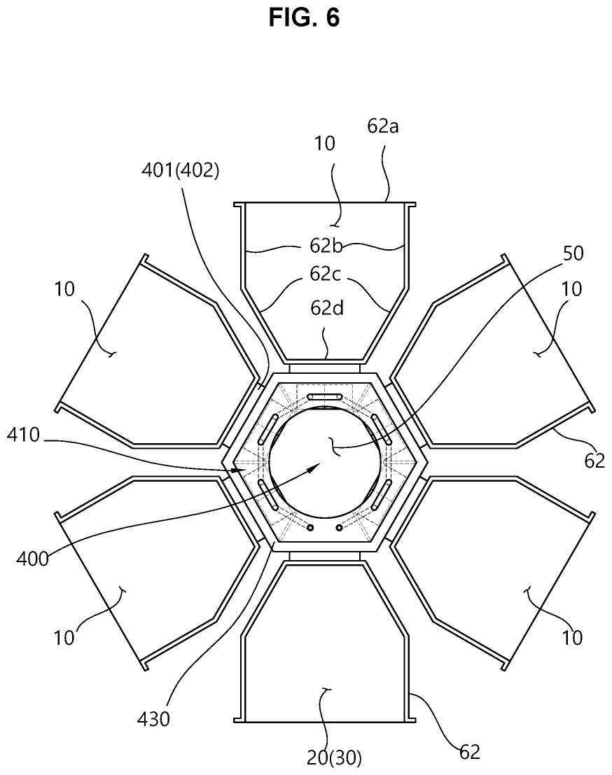

FIG. 6 schematically shows a horizontal section of a fermented beverage manufacturing apparatus.

The cell case 60 is closely attached along a circumference of the fermented beverage manufacturing apparatus. The cell case 60 shown in the drawing corresponds to the inner cell cases 62 defining a chamber, and the inner cell cases 62 may be positioned at regular intervals from each other in a circumferential direction. However, side surfaces of the cell case 60 may come into close contact with each other through the outer cell case 61.

The cell case 60 may be formed in a shape with a wide front and a narrow rear. In order to ensure an access space, left and right widths are constant up to a certain depth from the front to the rear but may become narrow backward. That is, the cell case 60 may have an approximately trapezoidal cross section.

Due to the shape of the cell case 60, the sidewall of the cell case 60 may be engaged with the sidewall of the adjacent cell case 60. In addition, the cell case 60 may be formed to sufficiently support vertical load in the form of a single block.

As described above, when the side walls of the cell cases are engaged with each other along the circumference (in the circumferential direction) of the fermented beverage manufacturing apparatus 1, the empty space 50 is formed at the rear of the cell cases.

When front surfaces of the cell cases form a hexagonal shape entirely and rear surfaces of the cell cases are parallel to the front surface, a space of a hexagonal shape is formed in the center of the fermented beverage manufacturing apparatus 1 as well. The space 50 may have a shape of a hexagonal column.

In the present embodiment, the evaporator assembly 400 may be configured using the empty space 50 in the middle of the fermented beverage manufacturing apparatus 1.

That is, cold air may be supplied to each chamber through the duct 411 surrounded by insulation and the evaporator 410 installed vertically in the duct. Here, it may be possible to simultaneously implement a duct function and an insulation wall function through a hollow insulation column with a hexagonal cross section without using a general metal duct. Therefore, the duct 411 may be a heat insulating wall column in which an evaporator is accommodated.

Side walls of each cell case 60 are engaged with each other, and rear walls of the cell case are engaged with the duct 411. Therefore, the empty space 50 may be automatically formed through the shape and engagement of the cell cases without a need to separately form a space for installing the duct. That is, the cell cases are provided to contact in vertical and circumferential directions, and may also be provided to contact in a radial direction through the duct 411 in the middle.

Here, since the empty space 50 is formed at the center of the fermented beverage manufacturing apparatus 1, cold air supply and cold air recovery may be performed smoothly and efficiently in a radial direction. In particular, since a flow of air to the outside of the empty space 50 may be separately excluded, loss of cold air may be minimized. This is because the duct 411 itself is formed of an insulating material and at the same time surrounds the duct with the cell cases 60 having an insulating wall.

The inlet 401 for cold air or a cold air outlet 402 is formed between the duct 411 and the cell case 60. The evaporator 410 is provided in the duct 411.

Hereinafter, the internal configuration of the keg chamber 10 will be described in detail through FIGS. 6 to 9.

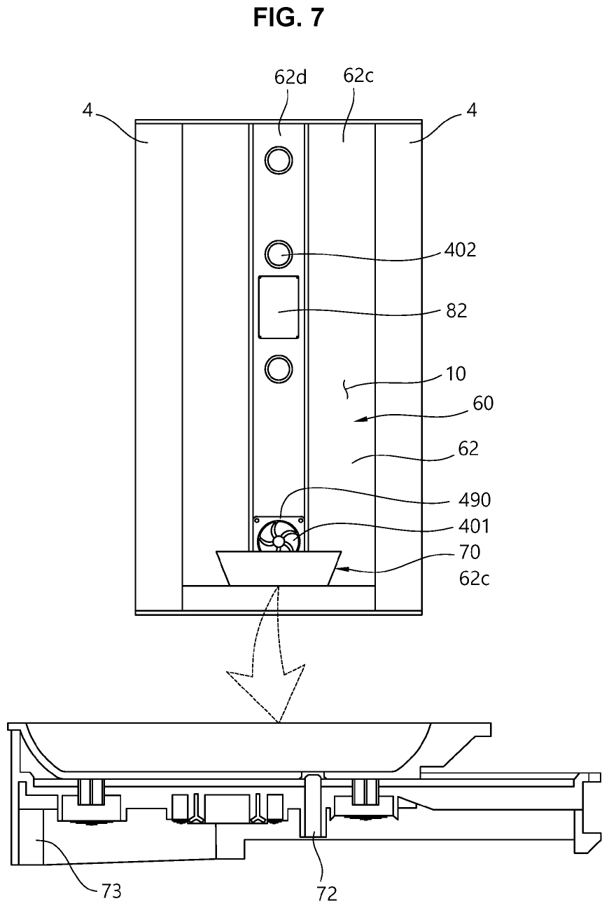

As shown in FIGS. 6 and 7, the keg chamber 10 is formed by the cell case 60 and an inner wall of the keg chamber 10 is formed by the inner cell case 62.

A front opening 62a is formed in the inner cell case 62, and side walls 62b and 62c are formed on both sides behind the front opening 62a. Both sides of a front sidewall 62b may be formed to be substantially parallel to form a wide entrance through a front opening 62b. On the other hand, a width between both sides of a rear sidewall 62c may be reduced backward. That is, a trapezoidal space that becomes narrower backward may be formed inside the inner cell case 62 by the rear sidewall 62c.

Based on the entire cell case 60 in which the inner cell case 62 is inserted into the outer cell case 61, the cell case 60 may include a front opening 61a, an upper wall 61b, a lower wall 61c, left and right walls 61d and 61e, and a rear wall 61f.

The upper wall and the lower wall extend from the top and bottom of the front opening to the rear, respectively, the left and right walls extend from the left and right of the front opening to the rear, respectively, and the rear wall is connected to the upper wall, the lower wall, the left wall, and the right wall from the rear of the front opening.

The left and right walls 61d and 61e may include front left and right walls 61d extending backward substantially parallel to each other from both sides of the front opening and the rear left and right walls 61e extending from the rear of the front left and right walls to the rear wall such that the left and right widths become narrow.

Due to the rear left and right walls 61e, the cell case 60 adjacent to each other may come into close contact with each other in a circumferential direction.

A rear wall 62d of the inner cell case 62 is formed as a flat vertical wall, and a fan 490 is mounted at a lower part of the rear wall 62d such that cool air heat-exchanged from an evaporator flows into the inner cell case. That is, the inlet 401 through which air is introduced may be formed below the rear wall 62d of the inner cell case 62.

In addition, the outlet 402 may be formed above the rear wall 62d of the inner cell case 62 to discharge air cooled inside the inner cell case to the outside of the inner cell case 62. The air discharged through the outlet 402 descends after exchanging heat with the evaporator 410, and may be introduced into the inner cell case 62 through the inlet 401 after exchanging heat with the evaporator 410 again. Needless to say, at this time, the fan 490 needs to be driven. Therefore, since the double heat-exchanged cold air flows into a chamber, very effective cooling may be performed.

Here, the size of the inlet 401 may be larger than the size of the outlet 402 for smooth intake and discharge of air. The shape of the inlet and outlet may be circular.

A cell printed circuit board (cell PCB) mounting part 402 may be provided on a rear wall of the inner cell case 62. In order to independently perform temperature control inside the keg chamber, flow module control, status control, and the like, a cell PCB may be mounted on the cell PCB mounting part.

Here, it may be seen that the cell PCB mounting part is provided between the inlet 401 and the outlet 402. Accordingly, since the PCB is mounted on a path through which cold air is introduced and discharged, smooth PCB cooling may be performed.

The keg supporter 70 on which a keg is to be accommodated may be provided below the inner cell case 62.

The keg supporter 70 may include a keg accommodation part 71, and the keg supporter 70 may include a door sensor 73 and a temperature sensor 72.

The temperature sensor 72 may be provided to be substantially closely attached to the keg accommodation part 71. That is, the temperature sensor 72 may be provided to be substantially in close contact with the bottom of the keg. Therefore, the temperature sensor 72 may be provided to very effectively sense the temperature of the undiluted solution or fermented beverage inside the most important keg.

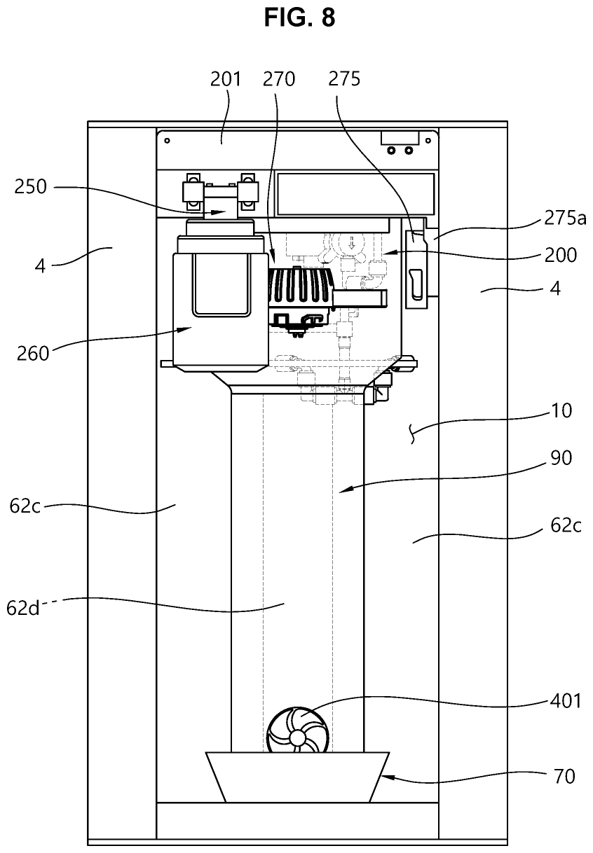

As shown in FIG. 8, the flow module 200 is mounted on the inside of the inner cell case 62, and the medium tank 260 may also be mounted. The medium tank 260 may be a part of the flow module 200.

In addition, the flow module 200 may include the coupler 270 provided to couple with a cap of the keg.

The flow module 200 may include various components such as a pump, a plurality of fittings, a plurality of tubes, and a plurality of valves. However, the flow module may be manufactured and installed as a single module, and may be formed as a compact module.

Through the rear wall 62d of the inner cell case 62 described above, cold air may be introduced and discharged and the cell PCB may be installed. Accordingly, the inlet/outlet of air and the cell PCB may be shielded from being exposed to the user. In addition, some components of the flow module 200 provided on top of the inner cell case 62 are also shielded. That is, only some components such as the coupler 270 or the medium tank 260 of the flow module 200 that need to be manipulated by a user may be exposed inside the inner cell case 62, and the other detailed components of the flow module 200 are shielded.

To this end, the inner cell case 62 may include a back cover 90.

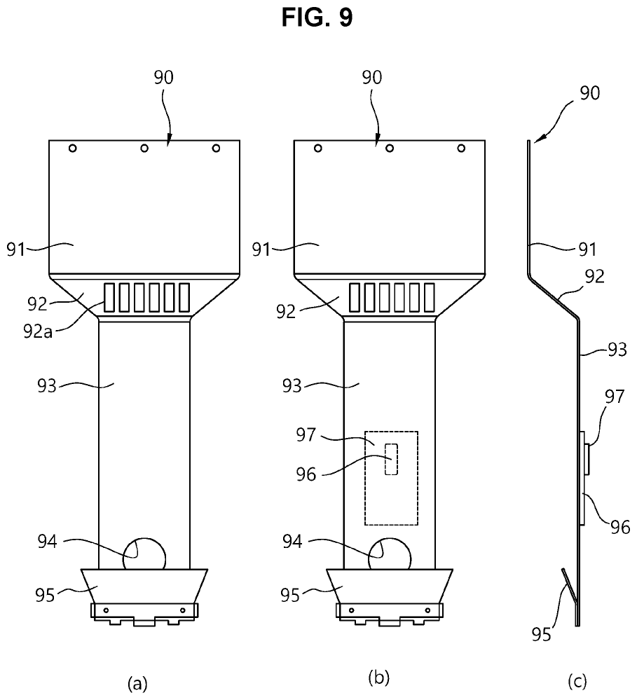

FIG. 9 shows a back cover, and FIG. 8 shows a state in which the back cover is mounted on the inner cell case 62.

The back cover 90 has a bent plate shape and may be formed of a steel plate. In particular, since a front surface of the back cover is exposed inside the inner cell case 62, the front surface of the back cover may be made of a stainless steel plate. In particular, the back cover may perform a heat plate function. Therefore, the back cover may be made of a steel plate, especially a stainless steel plate, not a synthetic resin. Needless to say, the back cover may be made of an aluminum material.

The back cover 90 is located in front of the rear wall 62d of the inner cell case 62 to form a certain space in the front and rear. That is, a space is formed between the rear wall 62d and a rear surface of the back cover 90, and connection lines between the cell PCB and the sensors 72 and 73 may be provided and shielded using the space. In addition, a space in which the fan 490 is mounted may be formed.

The back cover 90 may include a bottom plate 93 and a top plate 91. The back cover 90 may include a middle plate 92 provided between the bottom plate 93 and the top plate 91.

As shown in FIG. 9, the left and right widths of the top plate 91 may be greater than the left and right widths of the bottom plate 93, and the left and right widths of the middle plate 92 may increase from the bottom plate 93 to the top plate 91. The middle plate 92 may be bent between the bottom plate 93 and the top plate 91, and may be formed in an oblique shape from rear to front. Therefore, the top plate 91 is positioned more forward than the rear wall 62d compared to the bottom plate 93, and thus a larger space may be formed between a rear surface of the top plate 91 and the rear wall 62d. That is, a larger shielding space may be formed between the rear wall 62d and the top plate 91 at an upper part of the inside of the cell case 62.

In addition, a plurality of communication holes may be formed in the middle plate 92. The communication hole may be formed in the form of a slit 92a. Therefore, cold air may be introduced from the front of the back cover to the rear, and the cold air may be discharged to the outside of the chamber.

As shown in FIG. 8, except for components of the coupler 270 and the medium tank 260 of the flow module 200, various components may be provided in a space shielded by the top plate 91. In particular, a flow module case 201 constituting a flow module may be mounted above the inner cell case 62, and the pump 219 and a tube may be accommodated inside the flow module case 201.

Therefore, many components of the flow module may be shielded and fixedly supported through the flow module case 201 and the back cover 90. That is, components such as the coupler 270 for coupling with the keg and the tank coupler 250 for coupling with the medium tank 260 may be exposed, and other components may be shielded. An upper part of the back cover 90 may be combined with the flow module case 201.

The shielded space may be a space for forming a flow path connected to common components as well as independent components inside each chamber. That is, a portion of a flow path of a fermented beverage or a flow path of carbon dioxide to be connected to the flow module 200 may be located within the shielded space. In addition, a part of a flow path for discharging a cleaning liquid after cleaning the flow module may be located in the shielded space.

Accordingly, various flow paths may be connected to each other using a rear space of the inner cell case 62.

As shown in FIG. 9, a heater 96 may be provided on a rear surface of a back cover 97. The heater 96 may be a plate type heater. That is, a wide surface of the plate may be brought into close contact with the rear surface of the back cover 97. The heater 96 may be a silicon heater.

A thermostat for controlling a temperature for heating by the heater 96 may be provided. The thermostat may be provided in close contact with the heater 96.

Here, the heater 96 has a function of increasing a temperature inside the chamber during fermentation of an undiluted solution to ensure smooth fermentation. Accordingly, as the heater 96 is heated, heat may be well transferred to the back cover 90 having a larger area. That is, the back cover may perform a thermal diffusion plate function. Therefore, heat may be applied evenly inside the chamber.

As described above, since a space is formed between the back cover 90 and the rear wall 62d, connection lines connecting the heater 96 and a thermostat 97 to the cell PCB may be provided through the space.

An inflow hole 64 through which cold air flows into the inner cell case 62 may be formed in a lower part of the back cover 90, that is, in the bottom plate 93. A guide 95 for guiding cold air upward may be provided at a lower part of the inflow hole 64.

The guide 95 may be coupled to the bottom plate 93 by welding or the like, and the welded portion is hidden by the keg supporter 70.

As shown in FIGS. 3 and 8, the fermented beverage manufacturing apparatus 1 according to an embodiment of the present disclosure may include a coupler holder 275. As will be described later, the coupler holder 275 is a component that is selectively combined with the coupler 270, and is not used in a fermented beverage manufacturing process, a fermented beverage storage process, and a fermented beverage dispensing process. In other words, the coupler holder 275 is a component for cleaning the inside of the flow module 200, and may be combined with the coupler only during a cleaning process.

When the coupler holder 275 is needed, there is a possibility that the coupler holder 275 is invisible. This is because the component is not always used. For this reason, it is necessary to always have the coupler holder 275 inside the keg chamber.

As shown in the drawing, a holder mounting part 275a may be formed on a side wall of an upper part of the keg chamber. The coupler holder 275 may be fixed to the holder mounting part 275a or may be detachably attached thereto. The coupler 270 may be movably provided inside the keg chamber to be combined with each of the keg cap and the coupler holder provided at different positions, respectively. That is, the coupler 270 may be provided to be moved to some extent through tubes defining a flow path for an undiluted solution and a flow path for gas.

The coupler holder 275 may be detachably attached to the holder mounting part 275a using a magnet. When the outer cell case itself is made of a steel plate, it may be possible to fix the coupler holder using a magnet.

The coupler 275 constitutes a path for the fermented beverage and gas to move. The coupler 275 constitutes a path for a washing liquid to move. Therefore, in a process of using the fermented beverage manufacturing apparatus, the coupler 270 needs to always be combined with the keg cap or the coupler holder. The coupler 270 is provided with a sensor to check whether or not such coupling is performed, and when it is checked through the sensor that the coupler is coupled to the keg cap or the coupler holder, a normal state may be determined.

In the above, the case 2, in particular, the structure of the fermented beverage manufacturing apparatus 1 that may be manufactured using the plurality of cell cases 60 has been described.

In the above embodiment, the plurality of cell cases 60 are stacked in two upper and lower layers, and the fermented beverage manufacturing apparatus having a total of 12 cell cases by engaging six cell cases along a circumference has been described. That is, an embodiment of a fermented beverage manufacturing apparatus having a hexahedral shape has been described.

However, the fermented beverage manufacturing apparatus may have a quadrangular shape or a pentagonal shape, and may have a 7 or 8 angle. For example, the fermented beverage manufacturing apparatus may be substantially formed into a square, regular pentagon, regular heptagon, or regular octagon shape. Assuming that left and right lengths of the fermented beverage manufacturing apparatus are the same, as the angle increases, the number of chambers increases, but the size of the chambers inevitably decreases.

In the above-described embodiment, rear side walls of the cell case 60 are formed in a trapezoidal shape. Therefore, even if the number of the angles is changed only by a difference in inclination of the rear side walls, the rear side walls of the cell case 60 may be engaged with each other in the circumferential direction. Therefore, even if the number of the angles of the fermented beverage manufacturing apparatus is changed, the structure of the case 2 of the above-described fermented beverage manufacturing apparatus may be applied in the same way.

Hereinafter, a flow module for manufacturing a fermented beverage and components for dispensing the fermented beverage in the fermented beverage manufacturing apparatus 1 will be described in detail. In addition, cleaning, sterilization, or cleaning of the flow module and the component for dispensing will be described in detail.

Fermented beverages are prepared from undiluted solutions through various processes. Hereinafter, for convenience of explanation, the undiluted solution accommodated in the keg before preparation of the fermented beverage and the undiluted solution right before the final production of the fermented beverage are all referred to as undiluted solutions.

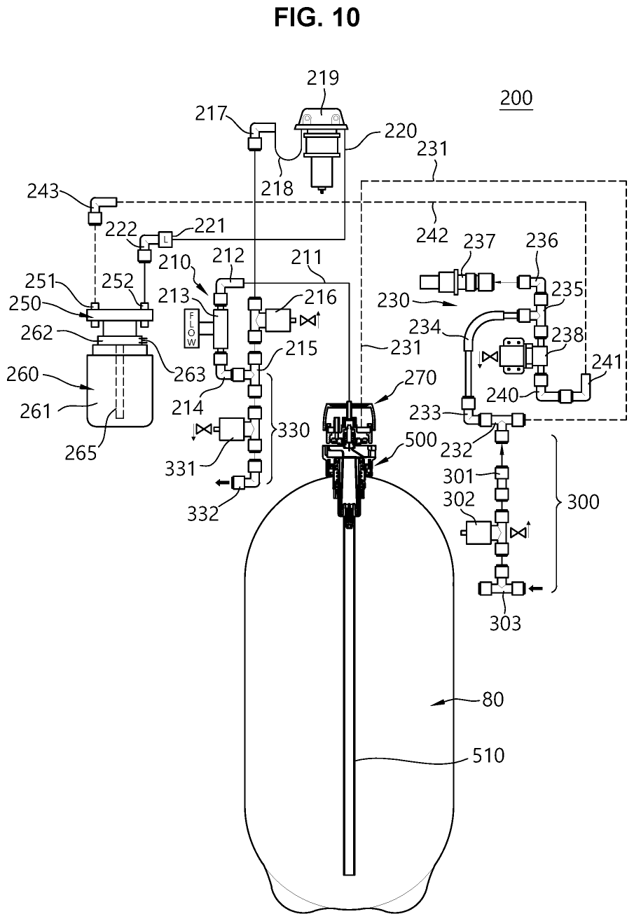

First, the flow module 200 will be described in detail with reference to FIG. 10.

A keg 80 accommodates an undiluted solution and manufactures the undiluted solution into a fermented beverage through a manufacturing process such as fermentation. Fermented beverages are accommodated in the keg 80. That is, until the fermented beverage produced from the undiluted solution is consumed, the undiluted solution and brewed liquor are always provided in the same keg 80. Needless to say, some of the undiluted solution is moved in the flow module during the fermented beverage manufacturing process, but in the end, all of the undiluted solution is recovered into the keg in a state in which the manufacturing of the fermented beverage is completed.

The keg 80 may include a keg cap 500, and after the keg 80 is placed inside the keg chamber in the state in which the undiluted solution is accommodated in the keg 80 and keg cap is mounted on the keg 80, the keg cap may be combined with the coupler 270. The inside of the keg 80 may not be completely filled with the undiluted solution, and air or carbon dioxide may be filled at an upper part of the inside of the keg. Needless to say, the inside of the keg 80 may be filled with nitrogen.

An undiluted solution hose 510 may be mounted on the keg cap 500, and the undiluted solution hose 510 may extend downward from the inside of the keg 80 to a vicinity of a bottom surface of the keg.

The keg cap 500 may be formed to distinguish a flow path that allows an undiluted solution (liquid state) to enter and exit and a flow path that allows gas (gaseous state) to enter and exit between the inside and outside of the keg. The flow path that allows the undiluted solution to enter and exit may be directly connected to an undiluted solution hose. The flow path that allows gas to enter and exit communicates with the top of the keg. Therefore, both the flow paths may form independent flow paths. When the coupler 270 is coupled with the keg cap 500, the coupler 270 may be provided to independently connect the inside of the keg to an undiluted solution flow path 210 and a gas flow path 230.

The undiluted solution flow path 210 is a flow path through which the undiluted solution flows, and the gas flow path 230 is a flow path through which gas flows. In particular, a flow path through which the undiluted solution or fermented beverage moves during the fermented beverage manufacturing process may be referred to as the undiluted solution flow path 210, and the flow path through which gas flows during the fermented beverage manufacturing process may be referred to as the gas flow path 230. Needless to say, the gas flow path 230 may form a part of a flow path that introduces carbon dioxide into the keg when the fermented beverage is dispensed.

Based on the coupler 270, the undiluted solution flow path 210 and the gas flow path 230 may be distinguished. Based on the medium tank 260, the undiluted solution flow path 210 and the gas flow path 230 may be distinguished. In FIG. 10, the undiluted solution flow path 210 is shown as a solid line and the gas flow path 230 is shown as a dotted line.

In order to manufacture a fermented beverage, it is necessary to move at least a part of the undiluted solution accommodated in the keg out of the keg. For example, in a process of supplying yeast to an undiluted solution or a process of infusing the undiluted solution, at least a part of the undiluted solution needs to be moved out of the keg and then moved back into the keg. A flow path through which the undiluted solution moves may be referred to as the undiluted solution flow path 210.

The pump 219 may be provided to move the undiluted solution in the keg 80 out of the keg. The pump 219 is provided in the undiluted solution flow path 210, and the undiluted solution introduced through the pump 219 may be supplied to the medium tank 260. Accordingly, a path from the coupler 270 to the medium tank 260 via the pump may be referred to as the undiluted solution flow path 210. When the pump 219 is driven in a reverse direction, the undiluted solution inside the medium tank 260 may flow into the keg through the pump 219. A flow path between the coupler 270 and the pump 219 may be referred to as a first undiluted solution flow path 211, and a flow path between the pump 219 and the medium tank 260 may be referred to as a second undiluted solution flow path 220.

The first undiluted solution flow path 211 is directly connected to the undiluted solution hose 510. In other words, when the pump 219 sucks the undiluted solution in the keg, air or gas does not flow into the first undiluted solution flow path 211 and only the undiluted solution may be sucked in the first undiluted solution flow path 211. That is, a component such as a tank in which negative pressure is generated inside the undiluted solution flow path when the pump is driven may be excluded by providing the pump 219 on the undiluted solution flow path 210. That is, there is no time delay between pump control and negative pressure release. Therefore, the pump for moving the undiluted solution may be precisely controlled, and a pressure deviation on the undiluted solution flow path may be generated smoothly. For this reason, it may be possible to precisely control the pump and enhance the durability of the pump.

When the pump is driven to move the undiluted solution inside the keg to the medium tank, the pump may be provided between the keg and the medium tank, according to the present embodiment. Therefore, when the pump is driven, the undiluted solution may be immediately sucked and may be moved to the medium tank through the pump.

On the other hand, in the case of the Cited Reference, a medium tank is provided between a keg and a pump. Therefore, when the pump is driven, negative pressure is generated in the medium tank, and then the undiluted solution inside the keg may flow into the medium tank. As a result, a time delay occurs between pump control and negative pressure release, and thus the pump control, that is, the undiluted solution flow control is not precise, and a pressure deviation in the undiluted solution flow path inevitably occurs momentarily. These problems may also occur in the cleaning process. Because, as will be described later, in a cleaning process, pressure is first applied to the medium tank and then a cleaning liquid circulates through the flow module, and thus there is a problem that the pump is overtaxed when resistance is generated due to a cleaning material in the flow path. Therefore, according to the present embodiment, it may be possible to easily resolve the problem of the Cited Reference.

The first undiluted solution flow path 211 may include a flow meter 213 and a pump valve 216. As the pump 219 is driven, the undiluted solution from inside the keg may flow into the pump 219 through the flow meter and the pump valve. The pump valve 216 may be a valve for opening and closing the undiluted solution flow path 210, and may be controlled to open when the pump 219 is driven.

The flow meter 213 performs a function of detecting a flow rate such that a fixed amount of undiluted solution flows, and performs pump control through the detected flow rate. To configure the compact first undiluted solution flow path 211, elbows 212 and 214 may be connected to both ends of the flow meter, respectively, and the elbow may be a one-way elbow.

In fitting, both directions mean that a socket with both sides to which tubes are to be connected is provided, and one direction means that a socket with only one side to which a tube is to be connected is provided. A side without a socket is exposed in the form of a tube, and the tube may be connected to a socket of other fittings or inserted into a flexible tube to be combined with the flexible tube.

The elbow 214 may be connected to a tee 215, the tee 215 may be connected to a pump valve 213, and the p valve 213 may be connected to a ‘U’ shaped curved pipe 218 through the elbow 217. The curved pipe may be connected to the pump 219.

The tee 215 may form a branch point in which the first undiluted solution flow path 211 branches, and may be connected to a fermented beverage flow path 330 for dispensing a fermented beverage at the branch point. The fermented beverage flow path 330 includes a dispensing valve 331 that selectively opens and closes the fermented beverage flow path, and the dispensing valve 331 may be connected to an elbow 332. The subsequent configuration of the fermented beverage flow path 330 will be described later.

Therefore, based on the branch point, the pump valve 216 is provided between the branch point and the pump 219 in the first undiluted solution flow path. Based on the branch point, the flow meter is provided between the branch point and the coupler. In addition, based on the branch point, the dispensing valve 331 selectively opening and closing the fermented beverage flow path 330 may be provided at a downstream side of the branch point.

The undiluted solution discharged from the pump 219 may flow into a container 261 of the medium tank 260 through the second undiluted solution flow path 220. The second undiluted solution flow path 220 may include a water level sensor 221. The water level sensor may be connected to an elbow 222. The second undiluted solution flow path 220 may be connected to the undiluted solution connection hole 252 of the tank coupler 250. That is, the undiluted solution may flow into the container 261 from the second undiluted solution flow path 220 through the undiluted solution connection hole 252.

Here, the capacity of the container 261 is relatively smaller than the capacity of the keg. Therefore, it is necessary to prevent an excessive amount of undiluted solution from flowing into the container. Therefore, driving of the pump may be controlled by installing the water level sensor 221 on the second undiluted solution flow path 220.

Specifically, the water level sensor 221 is not for sensing a water level inside the medium tank, but for sensing flow of liquid inside the water level sensor 221. A water level of the liquid flowing into the middle tank may be indirectly calculated based on a point of time when the liquid is sensed using an electrode.

That is, for infusing, the undiluted solution needs to flow into the medium tank to have an appropriate level. On the other hand, in the process of adding yeast, there is no need to add an undiluted solution into the medium tank. Accordingly, the undiluted solution may flow into the medium tank for a predetermined time after the water level sensor 221 detects the liquid. This is during the infusing process. On the other hand, in the yeast input process, driving of the pump may be stopped before the water level sensor 221 detects liquid, and when the water level detects liquid, driving of the pump may be controlled to be immediately stopped.

When the pump is driven in a forward direction, the undiluted solution inside the keg is supplied to the medium tank 260 through the undiluted solution flow path 210. When the pump is driven in a reverse direction, the undiluted solution inside the medium tank 260 flows into the keg through the undiluted solution flow path 210. That is, a moving direction of the undiluted solution is changed through forward and reverse driving of the pump, and in this process, it is possible to supply yeast to the undiluted solution or infuse the undiluted solution. Needless to say, a driving direction of the pump and a flow direction of the undiluted solution may be opposite.

A connection relationship between the medium tank 260 and the tank coupler 250 may be the same as that between the coupler 270 and the keg cap 500.

That is, the liquid is introduced into the tank through an undiluted solution connection hole 252 and a tank hose 265 directly connected thereto. The gas connection hole 251 of the tank coupler 250 is connected to the cap 162 of the medium tank. That is, the gas connection hole 251 is connected to an upper space inside the tank. Accordingly, the tank coupler 250 is connected to the medium tank 260 and independently connects the undiluted solution flow path 210 and the gas flow path 230. After all, the inside of the keg and the inside of the medium tank may be a space in which buffering is performed between liquid and gas.

Here, the pump 219 may be located at the uppermost part of the flow module. That is, the pump 219 may be located with high potential. The ‘U’ shaped curved pipe 218 may prevent a rapid pressure difference from occurring at both ends of the pump during reverse driving of the pump 219. When the pump is driven in reverse, substantially all of the undiluted solution accommodated in the medium tank may be discharged, and at a time when all of the undiluted solution is discharged, a rapid pressure difference may occur between both ends of the pump.

Therefore, the pump may be protected by preventing a rapid pressure difference from occurring at both ends of the pump 219 by artificially forming a differential head through a ‘U’ shaped curved pipe.

In the process of manufacturing a fermented beverage through the undiluted solution, the pump valve 216 may be operatively connected to the pump 219 and may be open and closed. On the other hand, in the manufacturing process, the undiluted solution before the fermented beverage is not dispensed unless there is a special reason. Accordingly, the dispensing valve 331 on the fermented beverage flow path 330 may always be closed during the fermented beverage manufacturing process. Needless to say, for dispensing, the pump valve 216 may be closed to exclude flow in the undiluted solution flow path 210 and the dispensing valve 331 may be open to generate flow in the fermented beverage flow path.

The undiluted solution inside the keg is fermented, and carbon dioxide is inevitably generated in this process. Needless to say, an appropriate pressure of carbon dioxide needs to be maintained, but a pressure caused by excessive carbon dioxide needs to be relieved.

In the process of relieving the excessive gas pressure, a part of the undiluted solution may be discharged together with the gas, and in particular, bubbles may be discharged together with the gas.

Therefore, gas such as carbon dioxide needs to be properly processed, and in this process, it is necessary to effectively prevent mixing between the undiluted solution flow path 210 and the gas flow path 230. In addition, it is necessary to effectively prevent contamination caused by discharge of bubbles or foreign substances to the outside during gas discharge.

To this end, in the present embodiment, the gas flow path 230 may be formed between the medium tank 260 and the coupler 270. Through the coupler 270, an upper space of the keg may communicate with the gas flow path 230 independently of the undiluted solution hose 510.

Specifically, a first gas flow path 231 is formed from the coupler 270 and a second gas flow path 242 is formed to be connected to a gas connection hole 251 of the tank coupler 250 after passing through a branch point. The gas connection hole 251 communicates with the upper space of the container 261 through a cap 262 of the tank. The upper space is located independently of the tank hose 265. Therefore, the intermediate tank is connected to each of the undiluted solution flow path and the gas flow path to communicate with the two flow paths, but may perform a buffer function of a liquid phase and a gas phase. That is, the medium tank 260 may perform an indirect connection function through buffering without directly connecting the undiluted solution flow path and the gas flow path.

A branch point of the first gas flow path 231 may be formed through a tee 232. A carbon dioxide flow path 300 may be connected to the branch point. The carbon dioxide flow path may be provided to supply pressure when the pressure inside the gas flow path 230 is low. In addition, the carbon dioxide flow path 300 may be provided to supply a dispensing pressure when dispensing fermented beverage.

The carbon dioxide flow path 300 may include a check valve 301 and may include a carbon dioxide valve 302 that selectively opens and closes the carbon dioxide flow path. The carbon dioxide flow path 300 is connected to a spaced apart carbon dioxide tank through a tee or elbow 303. The entire carbon dioxide flow path will be described later.

Carbon dioxide discharged from inside the keg may be discharged into the medium tank 260 through a first gas flow path 331 and a gas valve 238. The gas valve 238 may be provided to selectively open and close the gas flow path 230.

When fermenting the undiluted solution, a fermentation pressure needs to be properly controlled. That is, in order to detect a gas pressure generated during fermentation, the gas flow path 230 may include a gas pressure gauge 237. The pressure gauge 237 may be provided between the coupler 270 and the gas valve 238. That is, a pressure may be sensed through the gas valve 238 while the gas flow path 230 is closed.

In addition, the pressure gauge may be located downstream of a branch point in which a carbon dioxide flow path branches in the gas flow path 230.

The pressure gauge may be branched from the second gas flow path 242. That is, the pressure gauge may be located at the highest head on the gas flow path 230.

To this end, a semicircular curved pipe may be provided between a branch point 232 of carbon dioxide and a branch point 235 of a pressure gauge. The curved pipe 234 may be positioned vertically and may be positioned to maximize a differential head between both ends.

An elbow 236 is connected to the branch point 235 and then the pressure gauge 237 may be provided. That is, the pressure gauge 237 and the gas valve 238 are located on both sides of the branch point 235, respectively. Then, after the two elbows 240 and 241 are directly connected to each other, the second gas flow path is connected to the medium tank 260 through a tube.

In FIG. 10, the undiluted solution flow path 210 provided independently between the tank coupler 250 and the coupler 270 is shown as a solid line and the gas flow path 230 is shown as a dotted line. Here, the insides of the medium tank 260 and the keg 80 are communicated to be distinguished from the undiluted solution flow path and the gas flow path, respectively.

Here, the flow module 200 including the medium tank 260 and the coupler 270 may be configured and manufactured very compactly. Therefore, the flow module 200 may be configured using a plurality of fittings such as elbows or tees by minimizing the required tubes. Most components of the flow module 200 may be accommodated in or connected to the flow module case 201 as shown in FIG. 3, and compactly installed inside the chamber.

FIG. 10 shows a state in which the flow module is connected to the keg, which may correspond to a state of a fermented beverage manufacturing process or a storage process after completion of fermented beverage manufacturing. When all of the manufactured fermented beverage is dispensed and consumed, a new keg needs to be installed and the fermented beverage manufacturing process needs to be performed again. At this time, a process of sterilizing, cleaning or washing the inside of the flow module (hereinafter referred to as a cleaning process) may be performed.

This is because it is necessary to remove any residue that may remain inside the flow module. In addition, this is because the flavor of a previous fermented beverage may affect a new fermented beverage when a different type of fermented beverage is manufactured.

In the process of sterilization, cleaning or cleaning, distilled water or purified water is used, and substances with sterilization or cleaning components may be dissolved. In addition, rinsing may be performed using only distilled water or purified water after sterilization or cleaning through sterilization or cleaning components.

Therefore, the process of effectively cleaning the flow module is very important, which will be described later.

According to the present embodiment, fermented beverages provided inside a plurality of kegs may be dispensed through one dispenser assembly. Therefore, different fermented beverages may be mixed in the process of dispensing fermented beverages. In addition, after fermented beverage A is dispensed, fermented beverage B, which has a completely different flavor, may be dispensed. At this time, it is highly likely that the flavor of the fermented beverage A is added to the fermented beverage B. Therefore, a method to exclude mixing of flavors between fermented beverages is needed.

In addition, there is a need for a method of effectively and efficiently dispensing a plurality of fermented beverages through one dispenser assembly. This is because, when a plurality of dispenser assemblies are provided in a limited space, the fermented beverage manufacturing capacity is inevitably lowered.

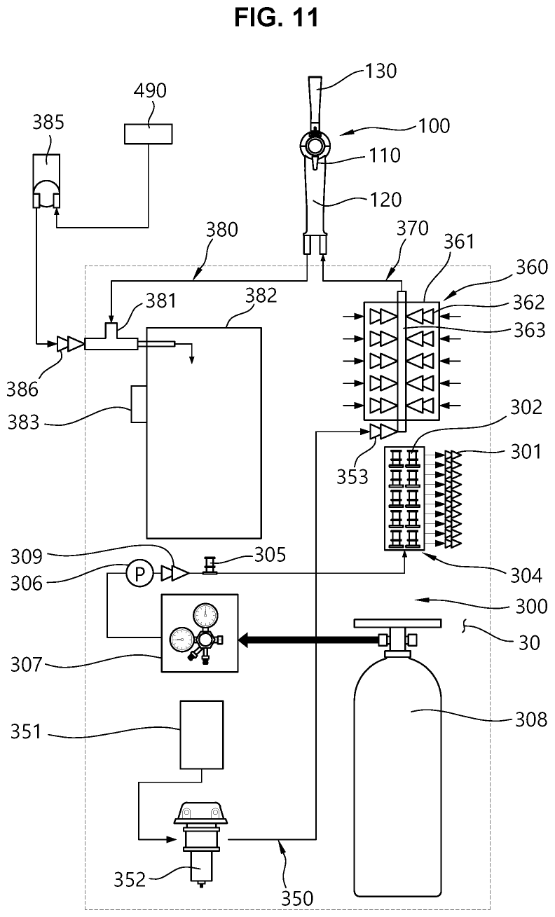

Hereinafter, with reference to FIG. 11, the structure and drain structure of the dispenser assembly applicable to the present embodiment will be described in detail.

In the present embodiment, carbon dioxide may be supplied into the keg to dispense the fermented beverage. That is, fermented beverage may be dispensed through the carbon dioxide supply pressure. In other words, the fermented beverage may be dispensed with gas pressure without a component such as a pump.

To this end, a carbon dioxide tank 308 may be provided and may be provided inside the common chamber 30. A region indicated by a dotted line in FIG. 11 may be referred to as a common chamber region. However, a header assembly 360 may be located in a rear space of the dispensing chamber instead of the common chamber 30. That is, the header assembly 360 may be shielded and provided behind the dispenser assembly 100.

It has been described that the carbon dioxide tank 308 is connected to the gas flow path 230 through the carbon dioxide flow path 300. Specifically, a pressure regulator 307, a pressure gauge 306, a check valve 309, and a flow path valve 305 may be provided to supply carbon dioxide to the plurality of gas flow paths 230 with one carbon dioxide tank. To this end, a carbon dioxide valve assembly 304 may be provided. The carbon dioxide valve assembly 304 may include a plurality of carbon dioxide valves as one assembly.

A plurality of the carbon dioxide valve 302 may be fixed and arranged to the base. When a total of 10 gas flow paths 230 are provided, 10 carbon dioxide valves 302 may also be provided and connected to the gas flow paths 230 of different keg chambers. The carbon dioxide valve assembly 304 may include the check valve 301.

Accordingly, a check valve and an on/off valve in the main flow path may be provided on the carbon dioxide supply path, and an on/off valve and a check valve may also be provided on the branch flow path. Therefore, reverse flow of gas may be doubly prevented.

The carbon dioxide tank may supply a constant pressure during the fermentation process and the dispensing process. For this, the pressure regulator 307 is located on the main flow path. Basically, the flow path valve 305 may be in an open state during the fermentation process or the dispensing process.

A plurality of the carbon dioxide valves 302 are selectively open and closed to independently supply carbon dioxide to the gas flow path.

The carbon dioxide flow path is prevented from flowing backward through the check valve 301. Therefore, the carbon dioxide flow path is a flow path in which only carbon dioxide flows. Therefore, there is no need to separately clean the inside of the flow path.

Referring to FIGS. 10 and 11, when the fermented beverage is dispensed, the corresponding carbon dioxide valve 302 is open, and carbon dioxide is introduced into the keg 80 through the gas flow path 230. That is, dispensing pressure may be provided. In this case, the gas valve 238 and the pump valve 216 are closed. The dispensing valve 331 may be open.

Due to the dispensing pressure, the fermented beverage inside the keg flows along an undiluted solution flow path, particularly the first undiluted solution flow path 211 and flows into the fermented beverage flow path 330. The fermented beverage flowing through the fermented beverage flow path 330 may flow along the cock flow path 370 and then be dispensed through a cock 110.

Here, the fermented beverage dispensed once through the single cock 110 needs to be the same. In other words, when a fermented beverage desired to be dispensed is selected, a fermented beverage flow path connected to the corresponding fermented beverage needs to be open.

Therefore, how to connect the plurality of fermented beverage flow paths 330 and the cock flow path 370 connected to the single cock 110 is very important.

To this end, the header assembly 360 may be provided in the present embodiment.

The header assembly 360 may include a header 363. The header 363 is provided to be connected to the plurality of fermented beverage flow paths 330. That is, the fermented beverage is supplied to the header 363 through the plurality of fermented beverage flow paths 330. Accordingly, the header 363 is a single flow path and may be regarded as a configuration for connecting a plurality of fermented beverage flow paths to one cock flow path 370.

Each of the fermented beverage flow paths 330 may be connected in a lateral direction of the header 363, and a check valve 362 may be provided at a connection portion therebetween. That is, the fermented beverage supplied from the specific fermented beverage flow path 330 to the header may be prevented from flowing backward to the other fermented beverage flow path 330. As described later, the washing liquid flowing into the header 363 may be prevented from flowing backward into the fermented beverage flow path 330.

The header assembly 360 includes a base 361, and the plurality of check valves may be fixed to the base.

Here, the header assembly 360 may be positioned as close to the dispenser assembly 120 as possible. That is, the length of a cock flow path 120 between the header assembly 360 and the cock 110 may be minimized. This is because an area in which the flavors of a plurality of fermented beverages need to mixed with each other. This is because the length of the cock flow path to be washed needs to be reduced. Therefore, the header assembly 360 may be provided in a rear space of the dispensing chamber.

When another fermented beverage is dispensed after a specific fermented beverage is dispensed, a residue or flavor of the specific fermented beverage may remain inside the header 363 and the cock flow path 370. Therefore, there may be a problem in that flavors of other fermented beverages are mixed with the fermented beverage currently being dispensed.

Therefore, the inside of the header and the cock flow path may be washed after a specific fermented beverage is dispensed. That is, a washing flow path may be formed.

To this end, a washing tank 351 accommodating a washing liquid may be provided, and a washing water flow path 350 may be provided between the washing tank 351 and the header 363.

Washing water provided in the washing tank may flow through the cock flow path 370 after flowing into the header 363 by driving a pump 352. Needless to say, the washing water may also be discharged through the cock 110.

A check valve 353 may be provided in the washing water flow path to prevent reverse flow of fermented beverage, and the washing water flow path 350 may be connected to the header 363 through the check valve 353. The washing water flow path may be connected in a longitudinal direction of the head.

Without the washing tank 351, externally purified washing water may be supplied to the washing water flow path. In this case, a washing water flow path valve may be provided instead of a pump. When the valve is open, washing water is supplied to the washing water flow path to wash the header and cock flow path.

Washing water washing the header 363 and the cock flow path 370 may be discharged to a drain tank 382 through a drain flow path 380. The drain tank 382 may be provided to accommodate not only the washing water, but also washing water for washing the flow module, defrost water of the evaporator, and remaining water of the dispenser tray 115. Therefore, it may be said that a cleaning frequency is relatively high.

The drain tank 382 may have a capacity of approximately 5 L, and therefore, may be accommodated in the common chamber 30 in consideration of capacity and cleaning frequency.

The drain tank 382 may be provided with a water level sensor 383 for notifying a cleaning time.

Defrost water from the defrost water tank 490 may flow into the drain tank 382 via a check valve 386 by driving a defrost water pump 385. A branch point 381 is formed on the drain flow path 380, through which defrost water may also flow into the drain tank.

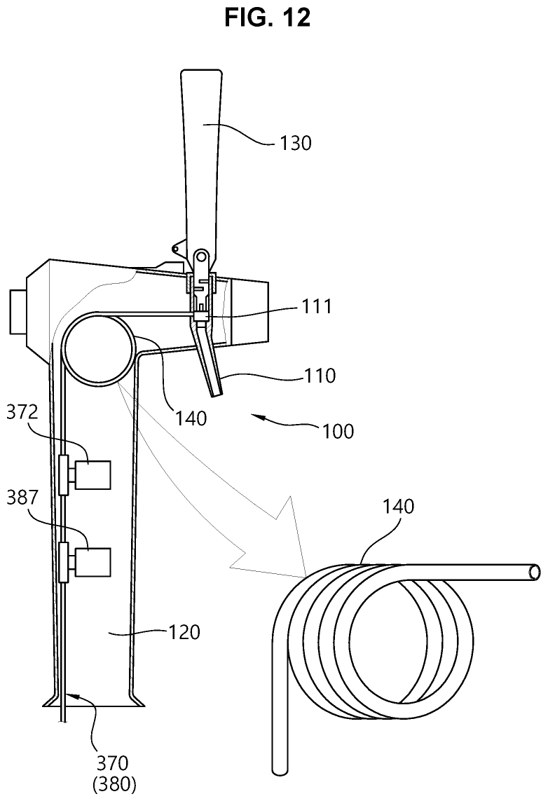

Hereinafter, the dispenser assembly 100 will be described in detail with reference to FIG. 12.

The dispenser assembly 100 may include a tower 120, a cock 110, and a lever 130. The lever may be a manual valve, and a stopper 111 may open or block the cock by manipulating the lever 130. In addition, when the lever 130 is manipulated, a dispensing signal connected to the lever 130 may be generated, and the corresponding dispensing valve, carbon dioxide valve and cock valve may be controlled to be open.

Here, the stopper 111 may be omitted, and manipulation of the lever 130 may not mechanically open the stopper, but may simply generate a dispensing signal.

Inside the tower 120, the cock flow path 370 and the drain flow path 380 may be formed.

Through the header, the fermented beverage may flow into the cock flow path 370, and when a cock valve 372 is open, the fermented beverage may be dispensed through the cock 110. Needless to say, during dispensing, an electrical signal needs to be maintained by maintaining manipulation of the lever 130.

Here, a bubble reduction unit 140 may be provided on the cock flow path 380. The bubble reduction unit may be provided to reduce bubbles in a fermented beverage dispensed through a cock. That is, the bubble reduction unit 140 may be provided to reduce bubbles by increasing flow path resistance.

The bubble reduction unit 140 may be provided downstream of the cock valve 372. The pressure of the fermented beverage discharged from the cock valve may not change rapidly until reaching the cock, but gradually changes through the bubble reduction unit 140. Therefore, the bubbles may significantly reduce the amount of dispensed fermented beverage through the cock may be significantly reduced.

On the other hand, when the bubble reduction unit is provided upstream of the cock valve, a rapid pressure change occurs between the cock valve and the cock.

Therefore, an effect of the bubble reduction unit 140 may be halved.

The bubble reduction unit 140 may include a tube wound in a coil shape a plurality of times. That is, the shortest distance between both ends of the bubble reduction unit 140 is very short, but a distance at which flow actually occurs may be significantly increased. Therefore, a pressure gradient may be gently formed by flow path resistance, and discharge of bubbles may be remarkably reduced.

The drain flow path 380 may be branched from the cock flow path 370 at a downstream side of the cock valve 372. A drain valve 387 selectively opening and closing the drain flow path 380 may be provided.

When the washing water flow path 350 is open and the washing water flows into the cock flow path 370, the washing water may be discharged to the cock or drain tank. When the drain valve 387 is open and the cock valve 372 is closed, the washing water is discharged into the drain tank. In an opposite case, the washing water is discharged into the cock. Therefore, it may be possible to wash not only the cock flow path 370 but also the inside of the cock with washing water.

When dispensing fermented beverage, the drain valve 387 may be open before the cock valve 372 and then closed. At this time, a very small portion of the fermented beverage may be discharged through the drain flow path 380. Then, the drain valve 387 is closed and the cock valve 372 is open, and the fermented beverage is discharged through a cock 111.

Accordingly, the flavor of the previous fermented beverage remaining over much of the header 363 and the cock flow path 370 may be dispensed as a cock after being replaced with the current fermented beverage. Therefore, the flavor of the previously fermented beverage may be effectively removed by properly controlling an operating timing and operation time of the drain valve and the cock valve, which may be possible due to a position in which the drain flow path is branched from the cock flow path and a positional relationship between the drain valve and the cock valve.

Needless to say, some bubbles and previously fermented beverages may be dispensed with the cock at a time of the first dispensing. Therefore, a portion of initial dispensing is dispensed in a separate empty container, and a desired fermented beverage may be dispensed in earnest. In an initial dispensing process, the flavor of the previously fermented beverage may be effectively removed.

As described above, when all of the fermented beverage accommodated in the keg is consumed, a new fermented beverage needs to be produced. At this time, the flavor or residue of the previous fermented beverage may remain inside the flow module. Therefore, a new fermented beverage may be prepared after the flow module is cleaned.

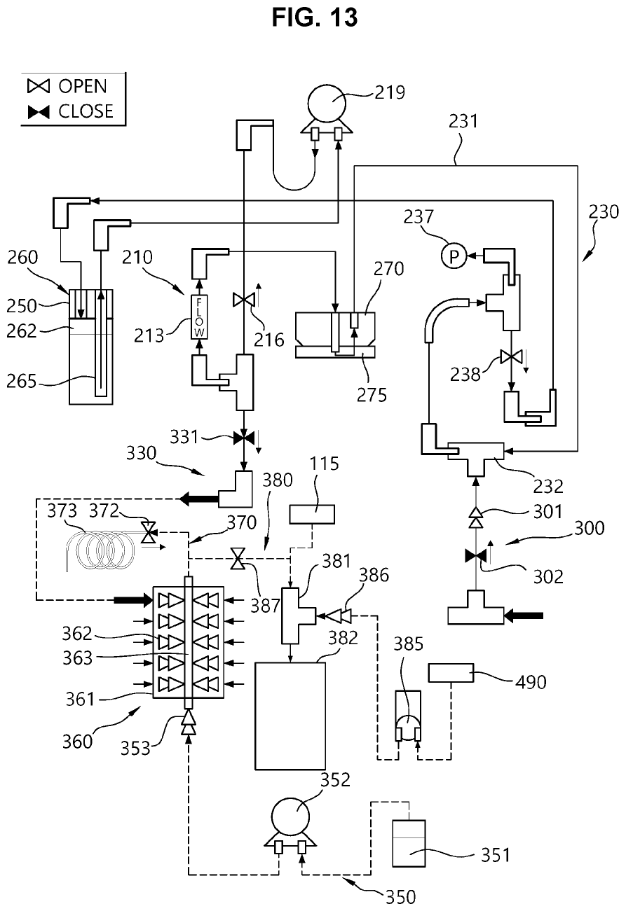

Hereinafter, the configuration and structure for cleaning the flow module will be described in detail with reference to FIGS. 13 to 15. FIGS. 13 to 15 briefly show flow paths including flow modules. A closed valve is shown with a filled valve icon, and an open valve is shown with an empty valve icon. A flow path in which a flow of liquid occurs is shown as a solid line, and a flow path in which a flow of liquid does not occur is shown as a dotted line. A valve on the flow path in which flow does not occur is shown as an empty valve icon for convenience.

When consumption of the fermented beverage is complete, the cake 80 is separated from the coupler 270. Instead, the coupler 270 is combined with the coupler holder 275. As the coupler holder 275 is coupled to the coupler 270, the undiluted solution flow path 210 and the gas flow path 230 are directly connected. That is, since a tank in which a gas-liquid buffer such as a keg is performed is omitted, direct cleaning solution flow is possible between an undiluted solution flow path and a gas flow path.

In addition, when consumption of the fermented beverage is completed, the medium tank 260 may be replaced or a cleaning solution may be filled therein. At this time, the medium tank may be referred to as a cleaning solution tank, not an infusing tank. This cleaning solution may be referred to as a liquid for cleaning the inside of the flow module 200.

First, as shown in FIG. 13, the cleaning solution contained in the medium tank 260 may be supplied into the flow module as the pump 219 is driven. At this time, the pump may be driven in a reverse direction.

The cleaning solution sucked through the tank hose 265 provided inside the container 261 flows into the pump 219 and is supplied to the coupler holder 275 through the coupler 270. That is, the cleaning solution flows inside the undiluted solution flow path 210. At this time, the pump valve 216 is open and the dispensing valve 331 is closed.

The cleaning solution supplied to the coupler holder 275 is supplied to the gas flow path 230 by pump pressure and then to the medium tank 260. Therefore, when reverse driving of the pump continues, the cleaning solution inside the medium tank 260 is returned to the inside of the medium tank after sequentially passing through the undiluted solution flow path and the gas flow path. As shown in the drawing, substantially the entire inside of the flow module may be cleaned by the cleaning solution by this driving. That is, the flow module 200 may configure one closed loop, that is, a closed flow path by the coupler holder, and the cleaning solution may be circulated. This process may be referred to as a first cleaning process.

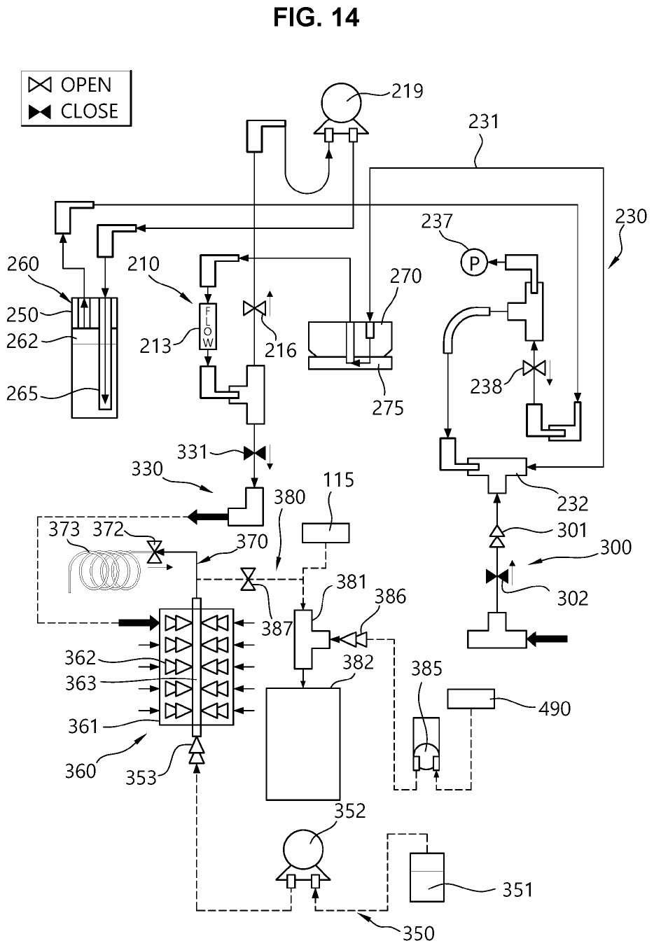

Then, the pump 219 may be driven in a forward direction. That is, as shown in FIG. 14, a process of recovering the cleaning solution remaining in the flow module to the medium tank may be performed. That is, a second cleaning process may be performed.

In this process, the pump sucks air through the gas flow path connected to the medium tank. The sucked air flows along the gas flow path, coupler holder, and undiluted solution flow path and is discharged into the tank through the tank hose of the medium tank.

Here, the cleaning solution remaining inside the flow module by the pressure of the sucked air may be recovered into the medium tank 260 very effectively.

After the second cleaning process is finished, carbon dioxide may be supplied to the gas flow path 230. That is, the residual cleaning solution in the flow path may be removed through the supply pressure of carbon dioxide. This may be referred to as an auxiliary cleaning process.

The first cleaning process and the second cleaning process may be repeatedly performed. Since a process in which cleaning is actually performed is the first cleaning process, an execution time of the first cleaning process may be longer than an execution time of the second cleaning process.

When the first cleaning process and the second cleaning process are finished, the inside of the flow module 200 may be cleaned. However, since cleaning of the fermented beverage flow path 330 needs to be performed, the fermented beverage flow path 330 may be effectively cleaned through a third cleaning process according to an embodiment of the present disclosure. That is, the fermented beverage flow path 330 may be cleaned through the medium tank, the flow module, and the fermented beverage flow path 330 without requiring an additional flow path or configuration. In the third cleaning process, the header 363, the cock flow path 370, the drain flow path 380, and the cock 111 may be cleaned.

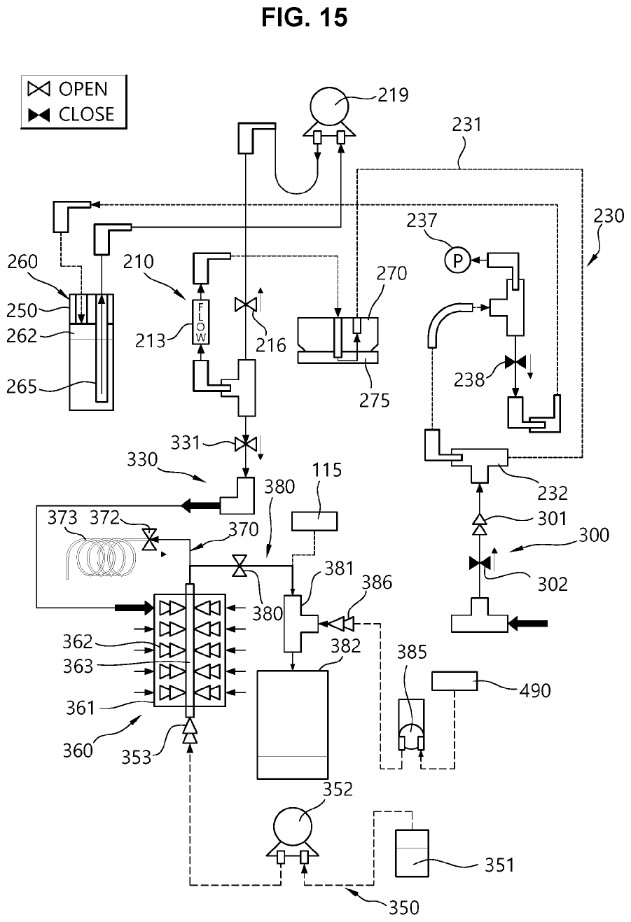

As shown in FIG. 15, when the first cleaning process and the second cleaning process are completed, the third cleaning process may be performed to clean the fermented beverage flow path and the like while discharging the cleaning water in the medium tank.

At this time, the dispensing valve 331 may be open while the pump 219 is driven in a reverse direction. The cleaning solution sucked from the tank hose of the medium tank 260 is discharged from the pump and flows into the fermented beverage flow path 330 via the pump valve 216 and the dispensing valve 331. At this time, the cleaning solution discharged from the pump flows in the fermented beverage flow path, not in a direction of the flow meter, by the differential head.

The cleaning solution supplied to the fermented beverage flow path 330 is supplied to the cock flow path 370 via the header 363. When the cock valve 372 is open, the cleaning solution may be discharged through the cock 111, and when the drain valve 387 is open, the cleaning solution may be discharged through the drain tank 382. Therefore, through the discharged cleaning solution, not only the flow module 200 but also the insides of the cock 111, the cock flow path 370 and the drain flow path 380 may be cleaned.

After the third cleaning process is finished, carbon dioxide may be supplied to the gas flow path 230. That is, the residual cleaning solution in the flow path may be removed through the supply pressure of carbon dioxide. That is, it may be possible to recover the remaining cleaning solution from the medium tank. This may be referred to as an auxiliary cleaning process.

When the cleaning is finished, the medium tank is replaced and a keg accommodating the undiluted solution is attached to the coupler to prepare a new fermented beverage.

In the above embodiment, the medium tank connected to the tank coupler may be omitted, and the tank coupler holder may be coupled to the tank coupler. A cleaning tank such as a keg may be connected to the coupler. Like the coupler holder, the tank coupler holder may directly connect the undiluted solution flow path and the gas flow path.

When a cleaning tank such as a keg is used, a relatively large volume of cleaning solution may be accommodated. Therefore, cleaning may be performed while repeatedly performing the above-described cleaning processes.

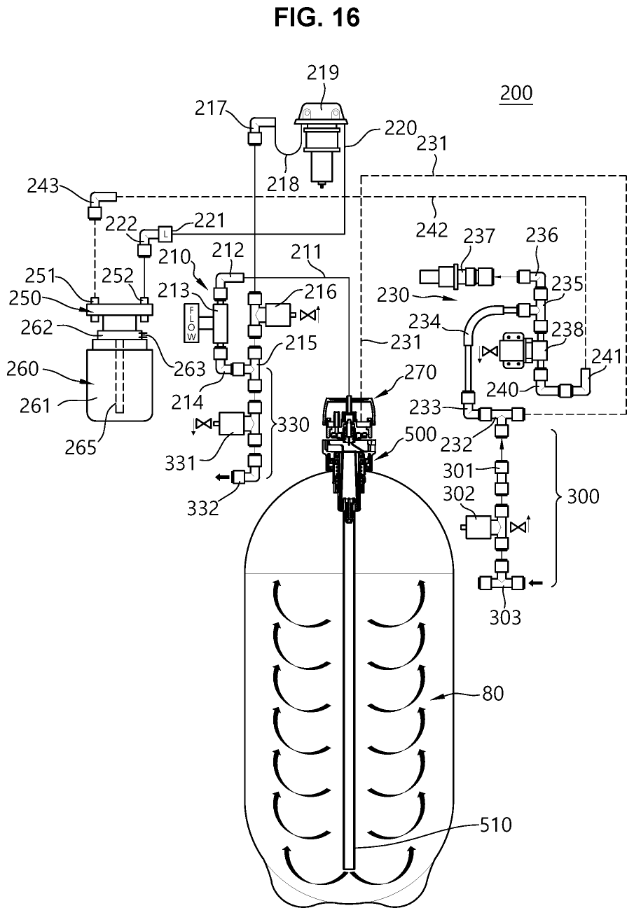

Hereinafter, a fermented beverage manufacturing process using a flow module will be described in detail with reference to FIGS. 16 to 21.

The undiluted solution contained in the keg 80 needs to be fermented by adding yeast to the undiluted solution before fermentation. That is, an yeast input process needs to be preceded.

In the present embodiment, yeast may be provided on the undiluted solution flow path 210. In particular, yeast may be provided inside the keg cap 500, and a capsule for accommodating yeast may be accommodated in the keg cap or integrally formed.

Therefore, in order to introduce yeast into the undiluted solution, as shown in FIG. 16, the process of discharging and recovering a part of the undiluted solution may be repeatedly performed. The mixing process is very effective and may be performed in a short time because yeast and undiluted solution are mixed in forward and reverse directions instead of mixing yeast and undiluted solution in one direction.

As shown in this process, the undiluted solution inside the keg flows entirely, and thus yeast may be evenly mixed in the undiluted solution.

The discharge and recovery of the undiluted solution may be performed only in some sections of the undiluted solution flow path. That is, the discharge and recovery only be performed up to a flow meter. In this process, the gas valve 238 may be open. Through this, repetition of discharging and collecting the undiluted solution may be performed smoothly. This is because it is easy to discharge and recover the undiluted solution only when gas discharge and recovery are allowed during this process.

When the yeast input process is finished, a primary fermentation process may be performed. At this time, fermentation may be performed at an appropriate pressure. That is, the fermentation pressure may be controlled in the primary fermentation process. As fermentation proceeds, it may be seen that fermentation bubbles are generated inside the keg.

At this time, the pump valve 216 and the dispensing valve 331 are closed, and the gas valve 238 and the carbon dioxide valve 302 are also closed. That is, fermentation efficiency may be increased by increasing the fermentation pressure. In other words, some of the undiluted solution flow path, the inside of the keg, and some of the gas flow path may form a closed space, and thus a pressure in the closed space may be increased as fermentation proceeds.

At this time, the pressure gauge 237 provided on the gas flow path 230 is also provided to detect the pressure in the closed space. Thus, this valve control is maintained until the preset pressure is reached, controlling the fermentation pressure to increase.

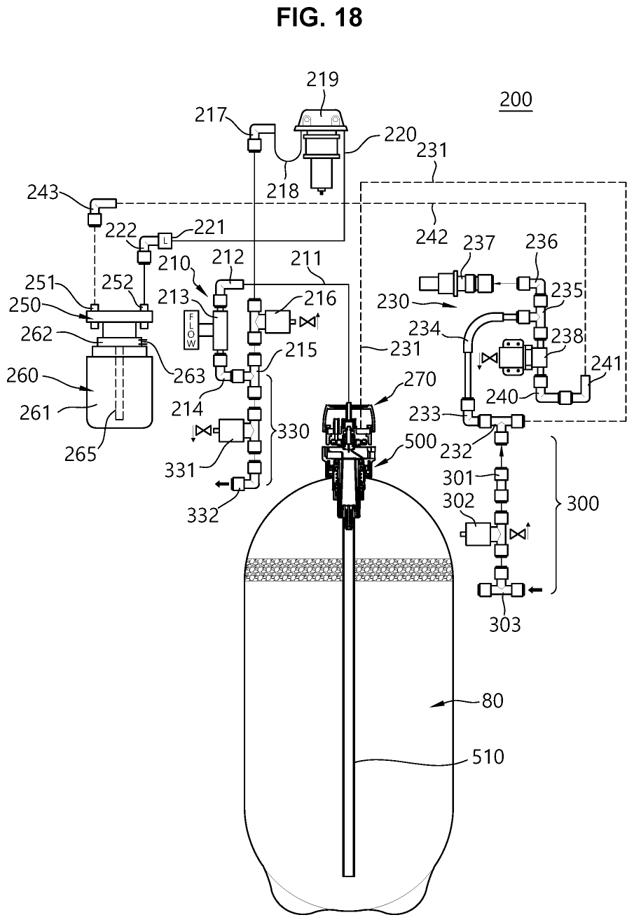

A predetermined pressure is reached, and as shown in FIG. 18, the fermentation foam is further increased. Therefore, a process of lowering the fermentation pressure is required.

During this process, the gas valve 238 may be open while maintaining the undiluted solution flow path closed. Accordingly, the fermented gas is discharged into the medium tank 260 while flowing along the gas flow path 230.

Here, when the gas valve 238 is open in a state in which the fermentation pressure is high, bubbles may be introduced into the gas flow path 230 together with the fermentation gas. Contamination may be a concern when the bubbles are discharged to the outside. However, in the present embodiment, the gas flow path 230 is connected to the medium tank.

Fermentation gas and bubbles discharged into the medium tank are accommodated inside the medium tank. Then, the fermentation gas is discharged to the outside by a vent 263 formed on the upper part of the medium tank. That is, bubbles remain inside the medium tank, and only the fermentation gas under excessive pressure is discharged to the outside. The size of the vent is very small, and thus a low pressure may be maintained in the gas flow path even when the gas valve is open.

The vent is shielded by the tank coupler and is not exposed to the outside. However, excessive pressure may be discharged to the outside of the medium tank through the vent.

Therefore, the primary fermentation process may be performed by repeatedly performing the pressure control and pressure release processes.

After the primary fermentation process, a process of infusing the undiluted solution may be performed. That is, a process of applying characteristics to the fermented beverage may be performed. Depending on a type of infusing, that is, a infusing raw material, very different fermented beverages may be produced.

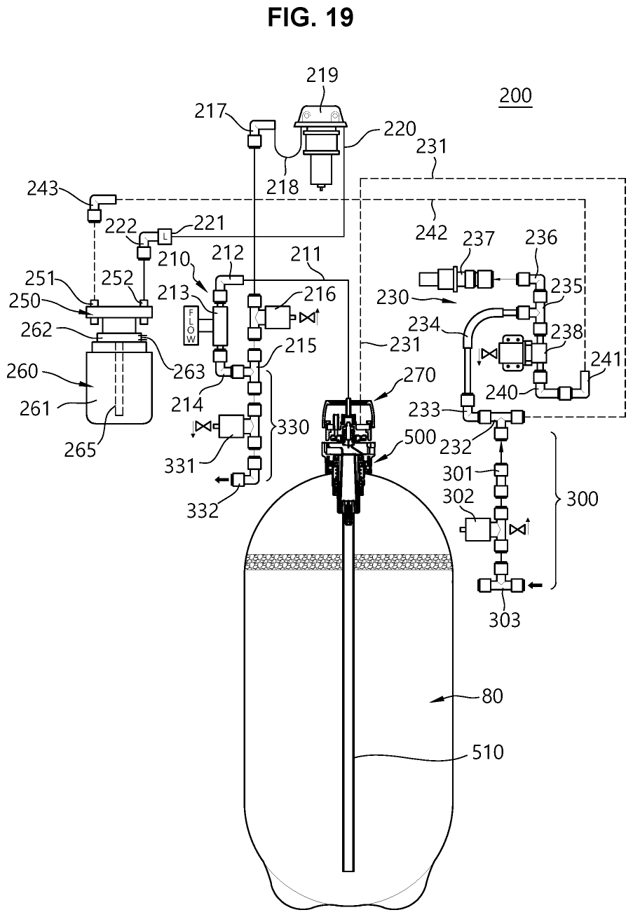

As shown in FIG. 19, the infusing process may be controlled in the same way as the yeast injecting process described above. However, the amount of undiluted solution discharged and recovered from the keg is different, and some paths for discharge and recovery may be different.

Infusing may be referred to as a process of injecting an undiluted solution into an infusing tank in which an infusing raw material is accommodated such that the undiluted solution extracts a characteristic flavor of the infusing raw material. Accordingly, the duration of infusing may be relatively long. Infusing may be repeatedly performed.

First, the pump is driven backward to supply the undiluted solution contained in the keg to the medium tank (infusing tank). At this time, a predetermined maximum amount of the undiluted solution may be injected into the medium tank. Thereafter, an infusing process is performed for a set time, and the infused undiluted solution is recovered back into the keg.

Dispensing, infusing, and withdrawing of the undiluted solution may be repeatedly performed. That is, these cycles may be repeatedly executed according to the fermented beverage manufacturing method. The infusing time or number of cycle repetitions may vary for each fermented beverage. That is, the infusing time or number of cycle repetitions may be preset according to the manufacturing method.

A secondary fermentation process may be performed after the infusing process.

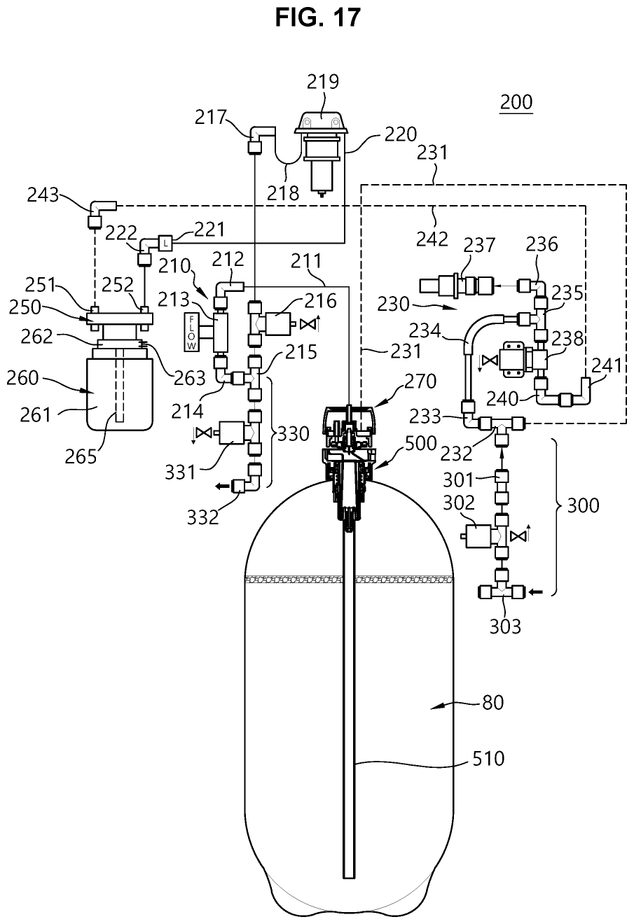

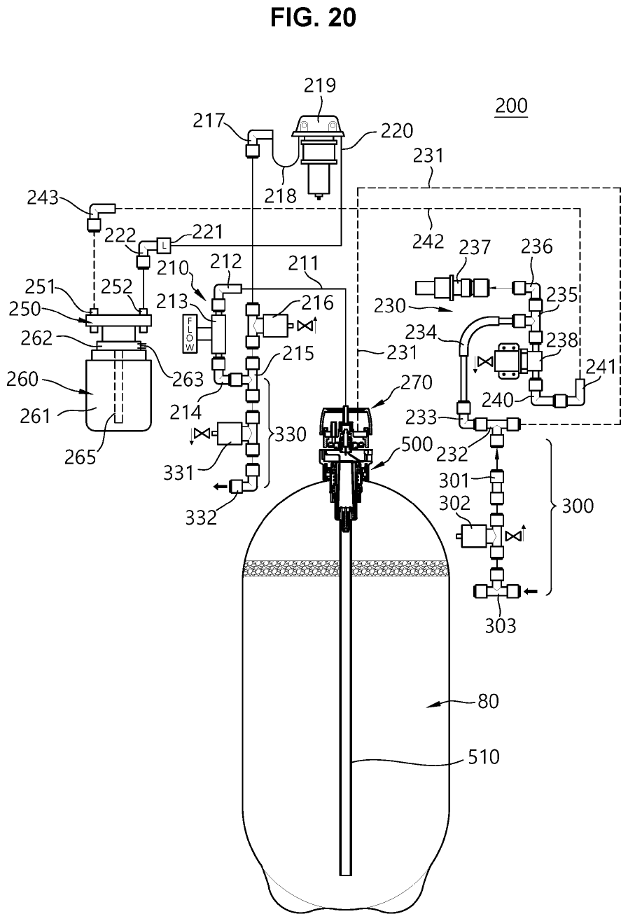

FIG. 20 shows a case in which a gas pressure is performed in the secondary fermentation process. Control at this time may be the same as or similar to the first fermentation in FIG. 17 and the pressure release in FIG. 18.

However, the pressure release in the primary fermentation process may be performed until the pressure is completely released on the gas flow path, but the pressure release in the primary fermentation process may release the pressure only up to a predetermined pressure. That is, opening of the gas valve may be maintained only until the pressure gauge detects a predetermined low pressure. This is to accommodate and maintain carbon dioxide at a predetermined pressure or higher in the fermented beverage after the secondary fermentation process.

When the secondary fermentation process ends, a process of aging the undiluted solution through a cooling process may be performed. A cooling temperature may vary depending on the manufacturing method of the fermented beverage.

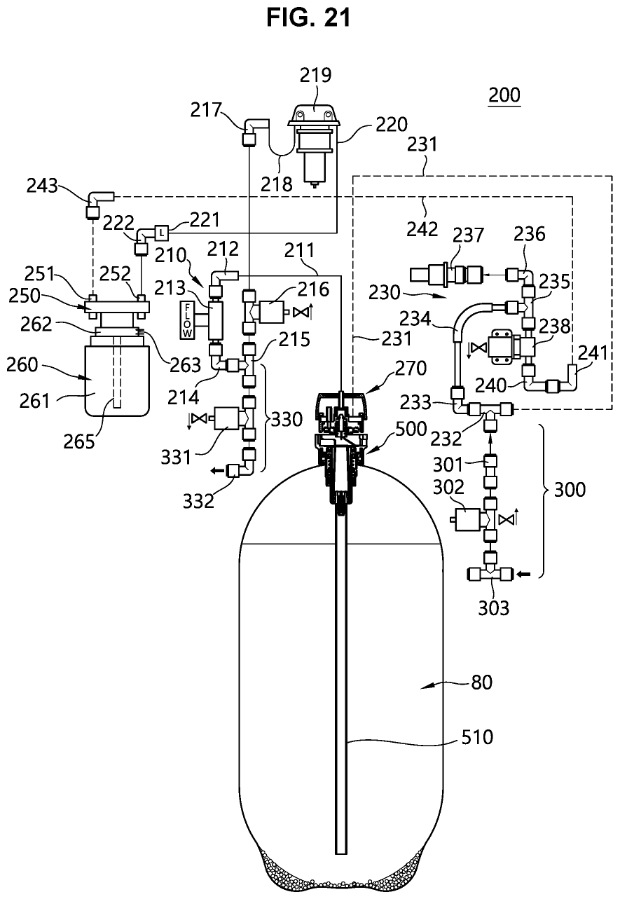

FIG. 21 shows control of a flow module in a ripening process. The undiluted solution flow path and gas flow path are closed and the carbon dioxide valve is open to maintain the inside of the keg at a predetermined pressure. During this cooling and maturation process, yeast may be finally settled on the bottom of the keg.

When the cooling and aging process is completed, the undiluted solution may be finally prepared as a fermented beverage.

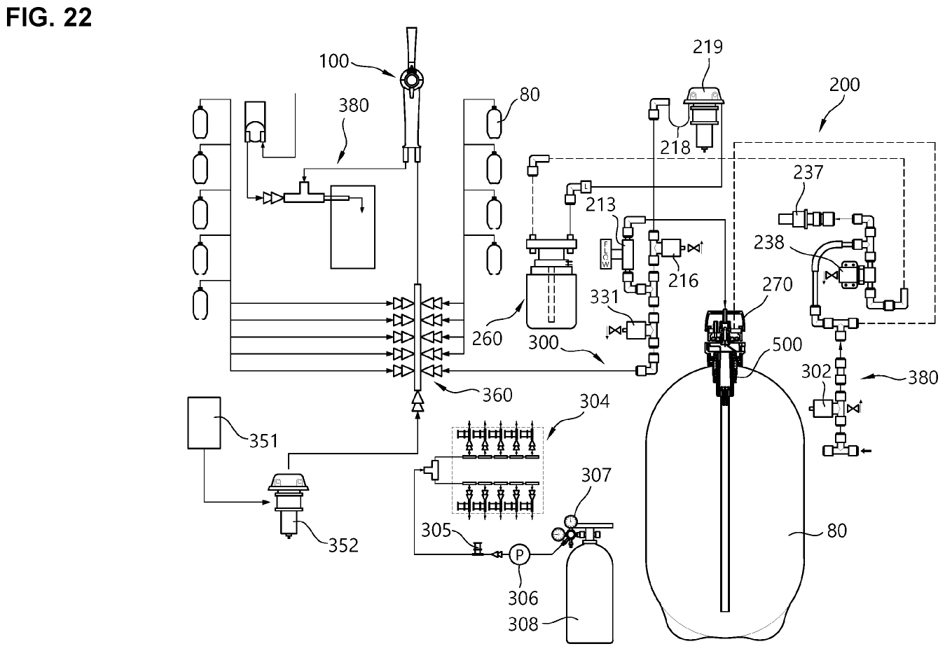

Through FIG. 22, the dispensing process of fermented beverage is explained.

When the carbon dioxide valve 302 is open and the dispensing valve 331 is open, carbon dioxide flows into the keg and fermented beverage flows into the fermented beverage flow path 330. Since the cock valve is open, the fermented beverage is dispensed through the cock 111 via the header assembly 360, and the cock flow path 370. Needless to say, a user needs to operate the lever at this time.

When dispensing is finished, the dispensing valve and the cock valve are closed, and the carbon dioxide valve remains open. Therefore, even if the dispensing is finished, the inside of the keg may be maintained at a predetermined pressure.

Therefore, since cooling and pressure maintenance are continuously performed even in the process of consuming fermented beverage, fresh fermented beverage may always be consumed.

In the above, an embodiment in which a fermented beverage dispensing apparatus for dispensing fermented beverage in a fermented beverage manufacturing apparatus is implemented has been described. However, the fermented beverage manufacturing apparatus and the fermented beverage dispensing apparatus may be formed through separate cases. That is, in the fermented beverage manufacturing apparatus, only fermented beverage is manufactured, and a separate fermented beverage dispensing apparatus may be provided to dispense the fermented beverage. In the latter case, flow paths through which fermented beverage and carbon dioxide are introduced may be connected between the fermented beverage manufacturing apparatus and the fermented beverage dispensing apparatus.

Therefore, the fermented beverage manufacturing apparatus according to an embodiment of the present disclosure may be separately manufactured and installed as an apparatus for manufacturing fermented beverage and an apparatus for dispensing fermented beverage. The flow paths connecting the two apparatuses will be equally applicable. However, the flow paths may be provided to connect between the two apparatuses without being entirely provided in one apparatus.

### INDUSTRIAL AVAILABILITY

This is included in the detailed description of the present disclosure.

1. A fermented beverage manufacturing apparatus including a flow module connected to a keg with an undiluted solution stored therein, the flow module comprising:
an undiluted solution flow path configured to move an undiluted solution therethrough;
a gas flow path configured to move gas therethrough;
a coupler configured to independently connect an inside of the keg to the undiluted solution flow path and the gas flow path while being coupled to a keg cap of the keg;
a medium tank provided between the undiluted solution flow path and the gas flow path and configured to communicate the undiluted solution flow path with the gas flow path; and
a pump provided on the undiluted solution flow path.

2. The fermented beverage manufacturing apparatus of claim 1, further comprising:
a tank coupler coupled to a cap of the medium tank and configured to independently connect an inside of the medium tank to the undiluted solution flow path and the gas flow path.

3. The fermented beverage manufacturing apparatus of claim 1, wherein:
when the coupler is combined with the cap of the keg, the flow module defines a closed flow path;
through driving of the pump, an undiluted solution is moved from the keg to the medium tank or from the medium tank to the keg via the pump; and
gas is moved from the medium tank to the keg or from the keg to the medium tank through the gas flow path.

4. The fermented beverage manufacturing apparatus of claim 1, wherein the undiluted solution flow path includes a first undiluted solution flow path provided between the coupler and the pump, and a second undiluted solution flow path provided between the pump and the medium tank.

5. The fermented beverage manufacturing apparatus of claim 4, further comprising:
a fermented beverage flow path branched from the first undiluted solution flow path and configured to dispense an undiluted solution inside the keg to an outside.

6. The fermented beverage manufacturing apparatus of claim 5, wherein the first undiluted solution flow path includes a pump valve and a flow meter configured to selectively open and close the first undiluted solution flow path.

7. The fermented beverage manufacturing apparatus of claim 6, wherein:
the pump valve is provided between the pump and a branch point at which the fermented beverage flow path is branched from the first undiluted solution flow path; and
the flow meter is provided between the branch point and the coupler.

8. The fermented beverage manufacturing apparatus of claim 6, further comprising:
a dispensing valve configured to selectively open and close the fermented beverage flow path on a downstream side of the branch point.

9-17. (canceled)

18. A fermented beverage manufacturing apparatus including a flow module connected to a keg with an undiluted solution stored therein, the flow module comprising:
a coupler holder;
an undiluted solution flow path configured to move an undiluted solution therethrough;
a gas flow path configured to move gas therethrough;
a coupler configured to directly connect the undiluted solution flow path and the gas flow path through the coupler holder when being coupled to the coupler holder;
a medium tank provided between the undiluted solution flow path and the gas flow path and configured to communicate the undiluted solution flow path with the gas flow path; and
a pump provided on the undiluted solution flow path.

19. The fermented beverage manufacturing apparatus of claim 18, wherein the coupler is coupled to the coupler holder during cleaning of the flow module, and coupled to a keg cap of the keg when a fermented beverage is manufactured through the flow module.

20. A fermented beverage manufacturing apparatus including a flow module through which an undiluted solution and gas are moved to manufacture an undiluted solution stored in a keg as a fermented beverage, the flow module comprising:
an undiluted solution flow path configured to move an undiluted solution therethrough in a process of manufacturing the fermented beverage;
a gas flow path configured to move gas therethrough in the process of manufacturing a fermented beverage;
a middle holder provided between the undiluted solution flow path and the gas flow path and configured to communicate the undiluted solution flow path with the gas flow path;
a pump provided on the undiluted solution flow path; and
a coupler connected to a cleaning tank accommodating a cleaning solution instead of the keg and configured to independently connect an inside of the cleaning tank to the undiluted solution flow path and the gas flow path when an inside of the flow module is cleaned.

21. The fermented beverage manufacturing apparatus of claim 1, further comprising:
a carbon dioxide flow path branched on the gas flow path and configured to supply carbon dioxide from a carbon dioxide tank to an inside of the gas flow path.

22. The fermented beverage manufacturing apparatus of claim 21, wherein a carbon dioxide valve, a check valve, and a carbon dioxide pressure gauge that are configured to selectively open and close the carbon dioxide flow path, and a pressure regulator configured to control a supply pressure of carbon dioxide supplied to the carbon dioxide flow path are provided on an upstream side of the branch point at which the carbon dioxide flow path is branched from the gas flow path.

23. The fermented beverage manufacturing apparatus of claim 22, wherein the carbon dioxide is supplied to the gas flow path through the pressure regulator, the pressure gauge, the check valve, and the carbon dioxide valve in sequence.

24. The fermented beverage manufacturing apparatus of claim 21, further comprising:
a gas valve configured to selectively open and close the gas flow path,
wherein the gas valve is provided between the medium tank and a branch point at which the carbon dioxide flow path is branched from the gas flow path.

25. The fermented beverage manufacturing apparatus of claim 24, further comprising:
a gas pressure gauge configured to detect a pressure inside the gas flow path between the gas valve and the branch point at which the carbon dioxide flow path is branched from the gas flow path.

26. The fermented beverage manufacturing apparatus of claim 25, wherein a branch point at which a flow path is branched is excluded on the gas flow path between the gas valve and the medium tank.

27. The fermented beverage manufacturing apparatus of claim 21, wherein, when the coupler is directly coupled to a coupler holder, the coupler directly connects the undiluted solution flow path and the gas flow path through the coupler holder.

28. The fermented beverage manufacturing apparatus of claim 27, wherein:
when the coupler is combined with the cap of the keg, the flow module defines a closed flow path; and
through driving of the pump, a cleaning solution accommodated in the medium tank is returned to an inside of the medium tank after flowing through an entire flow module.

29. The fermented beverage manufacturing apparatus of claim 21, wherein a flow path of the undiluted solution or gas is defined by the flow module in at least one of a process of supplying yeast to the undiluted solution, a fermentation process of the undiluted solution, and an infusing process.
